(19) United States
(12) Patent Application Publication
(10) Pub. No.: US 2010/0140416 A1
(43) Pub. Date: Jun. 10, 2010

(54) Ducted Fans with Flow Control Synthetic Jet Actuators and Methods for Ducted Fan Force and Moment Control

(76) Inventors: Osgar John Ohanian, III, Blacksburg, VA (US); Etan Karni, Christiansburg, VA (US); William Kelly Londenberg, Gloucester, VA (US); Paul A. Gelhausen, Yorktown, VA (US); Adam Lee Entsminger, Virginia Beach, VA (US)

Correspondence Address: LATIMER & MAYBERRY IP LAW, LLP, 13873 PARK CENTER ROAD, SUITE 106, HERNDON, VA, 20171, US

(21) Appl. No.: 12/611,463

(22) Filed: Nov. 3, 2009

Related U.S. Application Data
(60) Provisional application No. 61/110,689, filed on Nov. 3, 2008.

(51) Int. Cl. B64C 29/00

(52) U.S. Cl. 244/23 A

(57) ABSTRACT

The present invention relates to the field of aerodynamics. More particularly, the present invention relates to manipulating air flow over a surface, such as the surface of a duct of a ducted fan vehicle. By controlling air flow over, at, or around the surface of a duct, the flight of the vehicle can be controlled. One embodiment of the invention provides a vertical take-off and landing (VTOL) ducted-fan vehicle comprising means for producing steady or unsteady blowing at a surface of a duct for producing control forces and moments for controlling flight. The means for unsteady blowing can be provided by synthetic jets and the means for steady blowing can be provided by a pressurized air supply. The synthetic jets can be integrated into the ducted-fan vehicles in numerous ways, including at the surface of the leading and/or trailing edge of the ducts. The synthetic jets can be independently operated to control the flight of the vehicle. A novel use of these inventive flow control concepts is to apply the control asymmetrically to the duct in order to produce an imbalance in forces, thus resulting in a moment or torque, which can be used to control flight.

### CROSS-REFERENCE TO RELATED APPLICATIONS

This application relies on the disclosure and claims the benefit of the filing date of U.S. Provisional Application No. 61/110,689 filed Nov. 3, 2008, the disclosure of which is hereby incorporated by reference in its entirety.

### STATEMENT OF GOVERNMENT INTEREST

This invention was made partially with U.S. Government support from the United States Air Force under SBIR Contract No. FA8651-07-C-0091. The U.S. Government has certain rights in the invention.

### BACKGROUND OF THE INVENTION

1. Field of the Invention

The present invention relates to the field of aerodynamics. More particularly, the present invention relates to manipulating air flow over a surface, such as the surface of a duct of a ducted-fan vehicle. By controlling air flow over, at, or around the surface of a duct, flight of a ducted-fan vehicle can be controlled.

2. Description of Related Art

Controlling flight of unmanned air vehicles (UAVs), and in particular UAVs of the ducted-fan type, has long been a desire of those working in the field. Under certain flight or hover conditions, the flow over the duct lip can separate, affecting the thrust, lift, and pitching moment. It is a complex problem that depends on lip geometry, angle of attack, free stream velocity, and fan speed or rpm. See Graf, Will; Fleming, Jonathan; Ng, Wing; Gelhausen, Paul, “Ducted Fan Aerodynamics in Forward Flight,” AHS International Specialists' Meeting on Unmanned Rotorcraft, Chandler, A Z, January 2005; and Graf, Will, “Effects of Duct Lip Shaping and Various Control Devices on the Hover and Forward Flight Performance of Ducted Fan UAVs,” Masters Thesis, Virginia Tech, Blacksburg, Va., May 13, 2005.

Ducted fans experience large nose-up pitching moments during transition from hover to cruise (low speed and high angle of attack). A reduction in pitching moment would allow for lower control surface allocation during transition to forward flight and would improve wind gust rejection performance. Reducing the pitching moment of the vehicle under these conditions in a controlled manner is highly desirable.

It is known that with respect to ducted fan UAVs, a ducted fan produces more thrust than a fan (propeller) of the same diameter in isolation. See McCormick, B. W., Aerodynamics of V/STOL Flight, Dover Publications, 1999. This is due to the thrust/lift produced by the duct lip. In general, the pressures on the duct surface created by the flow induced by the fan are a large contribution to the overall forces and moments on the ducted fan unit.

More particularly, the high-speed flow into the duct induced by the fan causes a low-pressure region on the duct lip. This phenomenon results in a net force in the thrust direction during hover and can produce lift and pitching moment in forward flight. See Fleming, Jonathan; Jones, Troy; Ng, Wing; Gelhausen, Paul; Enns, Dale, “Improving Control System Effectiveness for Ducted Fan VTOL UAVs Operating in Crosswinds,” 2nd AIAA UAV Conference and Workshop & Exhibit, San Diego, Calif., September 2003.

Various methods for controlling flight have been used. Some have explored solutions to controlling the flight of spinning projectiles using synthetic jet actuators (SJA). See McMichael, J., A. Lovas, P. Plostins, J. Sahu, G. Brown, A. Glezer, “Microadaptive Flow Control Applied to a Spinning Projectile”, AIAA Paper 2004-2512, ^{2nd} AIAA Flow Control Conference, 28 Jun.-1 Jul. 2004, Portland, Oreg., 2004 (“McMichael 2004”).

Continuous or steady blowing for control forces and moments in hover has also been explored. See Kondor. S. and M. Heiges, “Active Flow Control For Control of Ducted Rotor Systems”, AIAA Paper 2001-117, Proceedings, 3^{9th} AIAA Aerospace Sciences Meeting & Exhibit, Jan. 8-11, 2001, Reno, Nev., 2001.

Similarly, the use of continuous blowing to enhance shrouded propeller static thrust has also been considered. See Kondor, S., W. Lee, R. Englar, M. Moore, “Experimental Investigation of Circulation Control on a Shrouded Fan”, Proceedings, 3^{3rd} Fluid Dynamics Conference, Jun. 23-26, 2003, Orlando, Fla. Paper No. AIAA-2003-3409; and Kondor, S., “Further Experimental Investigation of Circulation Control Morphing Shrouded Fan”, Paper AIAA 2005-639, Proceedings, 43rd AIAA Aerospace Sciences Meeting and Exhibit, Reno, Nev., 10-13 Jan. 2005.

Depending on the scale of ducted-fan aircraft, there may not be available volume or weight/power budget to implement a traditional flow control scheme. The advent of “zero net mass flux” actuators (another name for SJAs) has theoretically eliminated this hurdle, however, many technical issues must be overcome to successfully implement a system that can meet the performance requirements as well as weight, size, and power constraints of a UAV.

In this respect, synthetic Jet Actuators (SJA) have generated considerable research interest due to their potential use in applications where steady blowing flow control may not be feasible. See McMichael, J.; A. Lovas; P. Plostins; J. Sahu; G. Brown; and A. Glezer, “Microadaptive Flow Control Applied to a Spinning Projectile,” AIAA Paper 2004-2512, 2nd AIAA Flow Control Conference, 28 Jun.-1 Jul. 2004, Portland, Oreg., 2004.

Comparisons between steady and unsteady (synthetic) jets in isolation have been documented. See Smith, B. L., G. W. Swift, “A Comparison Between Synthetic Jets and Continuous Jets,” Experiments in Fluids, Vol. 34, 2003, pp 467-472. Other researchers have investigated synthetic jets on the stator blades of a ducted-fan to control vehicle rotation about the propeller axis. See Fung, P. H., M. Amitay, “Control of a Miniducted-Fan Unmanned Aerial Vehicle Using Active Flow Control,” Journal of Aircraft, Vol. 39, No. 4, 2002, pp 561-571. This work, however, falls short of the potential of controlling the flow over the duct lip or trailing edge of a duct in a ducted-fan vehicle.

Additionally, piezoceramic smart materials have been used for synthetic jet applications but not in the context of controlling flow over the lip or trailing edge of a duct of a ducted fan vehicle. See McMichael 2004. As a result, there remains a need for active flow control devices, which can be activated or de-activated on an on-demand basis during flight of a ducted-fan vehicle.

### SUMMARY OF THE INVENTION

The inventors have found that controlling the flow over the duct surface presents a large opportunity for affecting overall vehicle aerodynamics. Particularly, the inventors have found that employing unsteady blowing (synthetic jets), when applied to a tilting vertical take-off and landing (VTOL) ducted-fan vehicle, has not been explored by others but has great promise for enhancing vehicle control.

One objective of the present invention is to employ steady and/or unsteady blowing in the specific application of flow control, with a particular emphasis on using synthetic or steady jets for controlling hover as well as forward flight over a large range of angles of attack.

Another object of the present invention is to provide vertical take-off and landing (VTOL) ducted-fan vehicles comprising means for producing steady or unsteady blowing at a surface of a duct for producing control forces and moments for controlling flight. For example, means for unsteady blowing can be provided by synthetic jet actuators and means for steady blowing can be provided by a pressurized air supply.

In embodiment of the invention, the ducted-fan vehicles comprise vibrating diaphragms as the active component of the synthetic jets, such as piezoceramic or piezoelectric diaphragms. In such configurations, each piezo diaphragm is typically associated with a jet slot in the surface of the duct. The piezo diaphragms are capable of manipulating air flow at the jet slot in order to produce control moments and forces for controlling vehicle flight.

In particular embodiments, the jet slots can comprise from 0%-100% of the leading and/or trailing edge surface of a ducted-fan duct. Preferably, the slots can comprise up to about 75% of the leading edge surface and/or up to about 85% of the trailing edge surface, as a measure of a percentage of the circumference of the applicable surface of the leading edge or trailing edge of the duct. Other embodiments include slots comprising from about 10% to about 90% of the leading and/or trailing edge surfaces, or from about 25% to about 50% of the leading and/or trailing edge surfaces, or from about 30% to about 75% of these surface(s). Preferably, when controlling a particular section of the duct circumference, it is desired to have coverage of that section as close to 100% of the circumference of that section.

Of particular interest is an apparatus for causing separation between a surface of a ducted fan and a fluid flow comprising: a ducted fan having a duct with a leading edge surface; one or more slots in the leading edge surface disposed around a circumference of the leading edge surface, wherein each slot is an opening for an orifice; an orifice associated with each slot and operably connected thereto; a cavity associated with each orifice and operably connected thereto; at least one steady or synthetic jet operably associated with each cavity and capable of being individually actuated to blow a flow out of the cavity, through the orifice, and through the slot; such that during operation the flow from each slot is capable of causing a separation between the leading edge surface and a flow entering the duct; and such that during operation the jets are capable of being actuated asymmetrically around the leading edge surface to produce control forces and moments.

Particular embodiments may include such an apparatus wherein the slots comprise about 75% of the circumference around which the slots are arranged.

Such an apparatus further comprising a synthetic jet geometry: wherein the duct has an inside diameter and the slots are rectangular, have a width ranging from about 0.2% to about 0.5% of the duct inside diameter, and have a length ranging from about 5% to about 8% of the duct inside diameter; wherein the cavities have a diameter ranging from about 8% to about 10% of the duct inside diameter, and a width ranging from about 5% to about 8% of the cavity diameter; and wherein the orifices have a depth of about 10% of the cavity diameter, a width ranging from about 0.2% to about 0.5% of the duct inside diameter, and a length ranging from about 5% to about 8% of the duct inside diameter is also included.

In some embodiments according to the invention the orifices are oriented at about 45° relative to the leading edge surface, such that during operation the flow from the slots is capable of opposing, at about 45°, the flow entering the duct.

Ducted fans according to embodiments of the invention can be capable of providing propulsion to a vehicle.

The jets used in embodiments of the invention can be synthetic jets capable of providing unsteady blowing. For example, the jest can be synthetic jets comprising a piezoelectric diaphragm with an active surface forming a wall of the cavity.

Jets that can be used in accordance with the invention include jets capable of producing a lateral or normal-oriented flow whereby respectively, the flow from each slot, while in the cavity, is parallel (tangential) or perpendicular (normal) to the active surface of the piezoelectric diaphragm.

Also included within the scope of the invention is an apparatus for causing attachment between a surface of a ducted fan and a fluid flow comprising: a ducted fan having a trailing edge region comprising an inner duct surface and a Coanda surface; one or more slots in the trailing edge region disposed around a circumference of the Coanda surface, wherein each slot is an opening for an orifice; an orifice associated with each slot and operably connected thereto; a cavity associated with each orifice and operably connected thereto; at least one steady or synthetic jet operably associated with each cavity and capable of being individually actuated to blow a flow out of the cavity, through the orifice, and through the slot; such that during operation the flow from each slot is capable of causing a Coanda effect in a flow exiting the duct, whereby the flow exiting the duct has a tendency to attach to the Coanda surface; and such that during operation the jets are capable of being actuated asymmetrically around the circumference to produce control forces and moments.

In such an apparatus according to the invention, the slots can comprise about 85% of the circumference around which the slots are arranged, or depensing on the application anywhere from 0-100% of the leading edge or Coanda surface.

In particular embodiments, the apparatus can further comprise a synthetic jet geometry: wherein the duct has an inside diameter and the slots are rectangular or curved to follow the Coanda surface circumference, have a width ranging from about 0.2% to about 0.5% of the duct inside diameter, and have a length ranging from about 5% to about 8% of the duct inside diameter; wherein the cavities have a diameter ranging from about 8% to about 10% of the duct inside diameter, and a width ranging from about 5% to about 8% of the cavity diameter; and wherein the orifices have a depth of about 10% of the cavity diameter, a width ranging from about 0.2% to about 0.5% of the duct inside diameter, and a length ranging from about 5% to about 8% of the duct inside diameter.

The orifice of the jets can be disposed under and parallel to the inner duct surface to deliver, during operation, the flow from each slot in a direction tangential to the Coanda surface and the flow exiting the duct.

Other embodiments of the invention include a vertical take-off and landing (VTOL) ducted-fan vehicle comprising: a ducted fan with a duct having a leading edge surface and a trailing edge region with an inner duct surface and a Coanda surface; one or more slots in the leading edge surface, and optionally or alternatively in the trailing edge region, disposed around a circumference of the leading edge surface or Coanda surface, wherein each slot is an opening for an orifice; an orifice associated with each slot and operably connected thereto; a cavity associated with each orifice and operably connected thereto; at least one steady or synthetic jet operably associated with each cavity and capable of being individually actuated to blow a flow out of the cavity, through the orifice, and through the slot; such that during operation the flow from each slot in the leading edge surface is capable of causing a separation between the leading edge surface and a flow entering the duct, and the flow from each slot in the trailing edge region is capable of causing a Coanda effect in a flow exiting the duct, whereby the flow exiting the duct has a tendency to attach to the Coanda surface; and such that during operation the jets are capable of being actuated asymmetrically around the leading edge surface or Coanda surface to produce control forces and moments for flight control. Such ducted-fan vehicles according to the invention can be capable of providing propulsion.

In embodiments of the invention the ducted-fan vehicles can comprise synthetic jets with piezo diaphragms as the source for instigating a flow.

Methods of flight control of a ducted-fan vehicle are also encompassed by embodiments of the invention. Specific embodiments of such methods may comprise: deterring a flow entering a duct of a ducted-fan vehicle from attaching to a leading edge surface of the duct; and optionally or alternatively inducing a flow exiting the duct to attach to a Coanda surface of the duct; by actuating synthetic jets incorporated into the leading edge surface or Coanda surface to produce unsteady blowing and cause control forces and moments for controlling flight of the ducted-fan vehicle.

The jets in such method embodiments can be arranged to produce unsteady blowing at about a 45° angle relative to the leading edge surface.

In preferred embodiments, the synthetic jets are capable of independent operation and of providing asymmetric flow control around a surface of a duct for controlling motion of the vehicle during flight.

Also included within the scope of the invention are methods of flight control, for example, for a ducted-fan vehicle. Such methods can entail flow control of a fluid (typically, air) at a surface of a duct using synthetic jets incorporated into the duct surface for producing control forces and moments for controlling movement, e.g., flight.

By controlling flow over a duct surface of a ducted-fan vehicle (for example, flow turned, accelerated, separation eliminated or produced on demand) the flight of a ducted-fan vehicle can be optimized. Such optimization can be useful during operation of the vehicle, for example, for combating gusting winds. In a particular application of an embodiment of the invention, asymmetric lift from one side of the duct having attached flow, while the opposite side is separated, could be used as a control moment or to alleviate undesirable moments due to wind gusts. Further, for example, in other applications achieving attached flow on the entire duct during a typical stall condition could enhance vehicle performance and efficiency.

### BRIEF DESCRIPTION OF THE DRAWINGS

FIG. 1A provides a schematic of a representative synthetic jet configuration, namely flow emerging from the jet normal to the source of the flow.

FIG. 1B provides a schematic of a representative synthetic jet configuration, namely flow emerging from the jet in a lateral or tangential direction relative to the source of the flow.

FIG. 2 provides a schematic of a ducted-fan vehicle, showing attachment and separation of flow at the duct lip caused by turning blowing off and on.

FIGS. 3A and 3B show a schematic of manipulating flow in the vicinity of the trailing edge of a duct by employing blowing techniques.

FIG. 4 shows one embodiment of how synthetic jets can be integrated into the leading edge surface of a ducted fan.

FIG. 5 shows one embodiment of slot geometry and orientation around the surface of the leading edge, which may be used according to the invention.

FIG. 6 shows one embodiment of how synthetic jets can be integrated into the trailing edge region of a ducted fan.

FIG. 7 shows one embodiment of slot geometry and orientation around the surface of the trailing edge, which may be used according to the invention.

FIGS. 8A-C provide a visual representation of a flow entering a ducted fan with respectively no blowing of jets, 100-ft/sec blowing, and 200-ft/sec blowing at the leading edge surface of a ducted fan.

FIG. 9 shows a cross-sectional view of a duct, emphasizing trailing edge geometry of an embodiment of the invention.

FIGS. 10A-D provide a visual representation of the results of analysis of trailing edge blowing with a rounded bluff step geometry.

FIG. 11 provides an illustration of the balance and vehicle used for the wind tunnel testing, along with the coordinate system used for collecting data.

FIG. 12 illustrates the coordinate system used for collecting data along with the angle of attack convention (similar to a helicopter).

FIGS. 13A-B show respectively leading edge and trailing edge blowing configurations used to quantify the effectiveness of SJAs.

FIG. 14A shows a rear perspective view of a ducted-fan vehicle according to embodiments of the invention.

FIG. 14B shows a detailed view of a portion of the ducted-fan vehicle shown in FIG. 14A.

FIG. 15 shows a front perspective view of a duct, showing the leading edge flow control duct lip installed in a ducted-fan vehicle.

FIGS. 16A-B show a rear perspective view of a ducted-fan vehicle during operation with flow through the duct separated or attached to the Coanda surface depending on whether jet flow control is off or on.

FIGS. 17A and 17B show a front perspective view of a ducted-fan vehicle during operation to provide visualization for leading edge flow control for a 35 ft/s free-stream flow at an angle of attack of −20 deg.

FIG. 18 is a graph of the normal force coefficient data versus jet momentum coefficient for static tests relating to trailing edge flow control.

FIG. 19 is a graph of the effect on axial force of the trailing edge blowing.

FIG. 20 is a graph showing the effect of trailing edge blowing on pitching moment coefficient.

FIG. 21 provides a graph showing the baseline vehicle coefficient data for a pitch sweep at 35 ft/s.

FIG. 22 is a graph showing the delta to normal force imparted from steady and synthetic jet blowing at the trailing edge of the ducted fan.

FIG. 23 is a graph showing the delta to axial force imparted from steady and synthetic jet blowing at the trailing edge of the ducted fan.

FIG. 24 is a graph showing the delta to pitching moment imparted from steady and synthetic jet blowing at the trailing edge of the ducted fan.

FIG. 25 is a graph showing the delta to pitching moment imparted from steady and synthetic jet blowing at the leading edge of the ducted fan.

FIG. 26 is a graph showing the delta to axial force imparted from steady and synthetic jet blowing at the leading edge of the ducted fan.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail. Thus, the following detailed description is not to be considered as limiting the invention to the embodiments described. Rather, the true scope of the invention is defined by the claims.

The inventors have found that steady blowing and unsteady blowing (synthetic jets) can be used to accomplish such flow control. For steady blowing, a high-pressure air supply is typically needed. In general, for synthetic jet blowing, Piezoceramic diaphragms, pistons, and electro-magnetic elements such as speakers can be used. Typically, synthetic jets employ a cavity that changes volume at a set frequency, causing an oscillatory flow to emanate from an orifice.

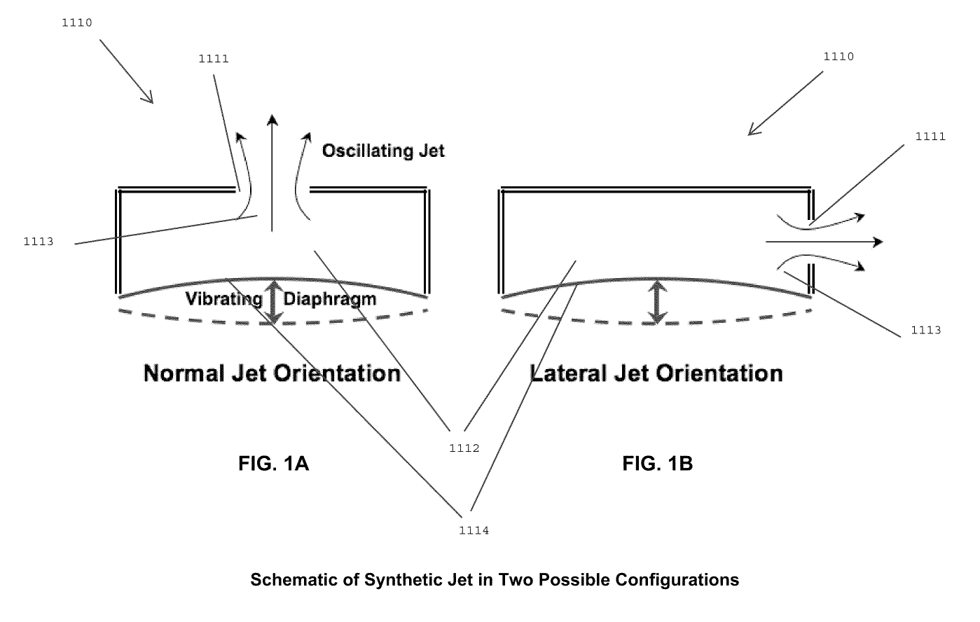

FIG. 1A provides a schematic of a representative configuration for a synthetic jet 1110, with flow emerging from the jet normal to the source of the flow. As shown in FIG. 1A, synthetic jet 1110 (also referred to as synthetic jet actuators, actuators, oscillating or oscillatory synthetic jets, acoustic jets, unsteady jets, and zero net mass flux jets) is shown having a slot 1111 from which flow can emerge. Operably associated with slot 1111 is orifice 1113 and cavity 1112. The source of the flow in this jet configuration is a vibrating diaphragm 1114, which vibrates and causes a flow in the fluid (typically air or gas) contained in cavity 1112. The flow (shown by arrows in FIG. 1A) is normal or perpendicular to the surface of the diaphragm 1114. As a result this jet configuration is commonly referred to as normal jet orientation.

FIG. 1B provides a schematic of a representative configuration for a synthetic jet 1110, with flow emerging from the jet in a lateral or tangential direction relative to the source of the flow. As shown in FIG. 1B, synthetic jet 1110 is shown having a slot 1111 from which flow can emerge. Operably associated with slot 1111 is orifice 1113 and cavity 1112. The source of the flow in this jet configuration is also a vibrating diaphragm 1114, which vibrates and causes a flow in the fluid contained in cavity 1112. The flow (shown by arrows in FIG. 1B) is pushed through slot 1111 in a direction parallel or tangential to the surface of the diaphragm 1114. As a result, such a jet configuration is commonly referred to as tangential blowing.

If the unsteady flow is fast enough, it entrains additional flow through generated vortices, producing a jet in the working medium. In this particular example, the mechanism to achieve this separation control on the duct lip is made possible through the use of Piezoceramics. Piezoceramic diaphragms can cause oscillating synthetic jets (zero net mass flux) that can be used to excite the flow over the duct lip or trailing edge.

Separation of the flow with respect to the leading edge can be used to affect thrust and pitching moment. One way to cause separation in the flow at the region of the duct lip (leading edge) is to apply the jet flow against the natural flow over the duct lip thereby causing the flow to separate. When the jets are turned off, the flow naturally reattaches to the duct.

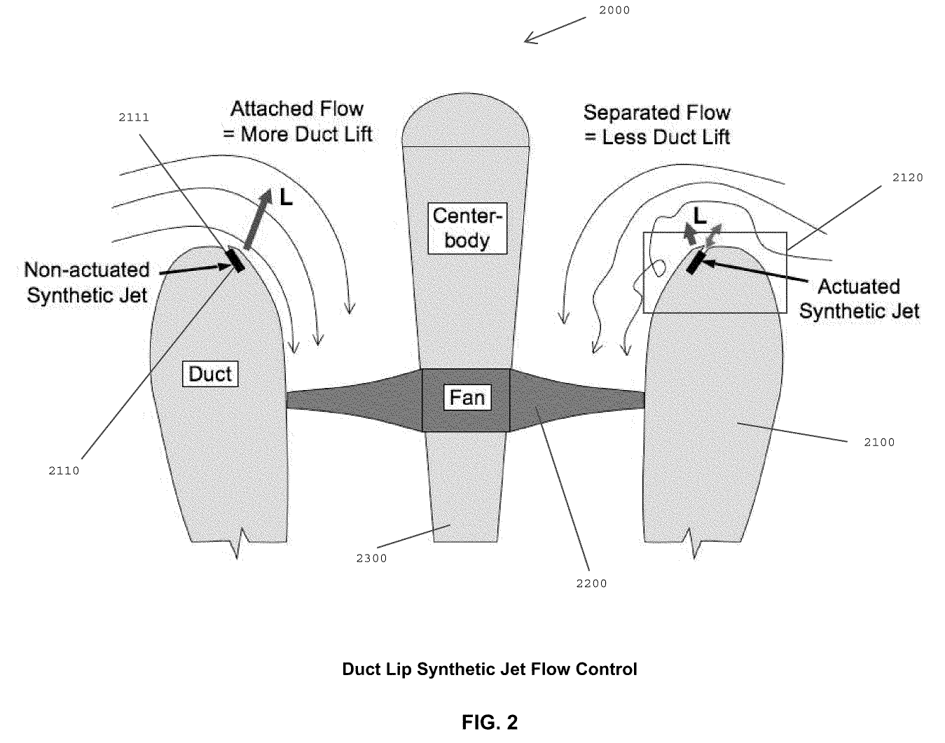

FIG. 2 provides a schematic of a ducted-fan vehicle 2000, showing attachment and separation of flow at the duct lip caused by turning blowing off and on. As demonstrated in FIG. 2, flow over, at, or around the surface of the leading edge region 2120 of the duct (typically referred to as the leading edge) of a ducted-fan vehicle can be manipulated with steady or unsteady blowing. FIG. 2 provides a schematic of a typical ducted-fan vehicle 2000 having a body 2300, fan 2200, and a duct 2100 shrouding the fan 2200. As shown, an attached flow in the vicinity of the leading edge region 2120 of the duct 2100 (with jets off or not actuated) can be caused to separate from the surface of the duct at the leading edge by actuating synthetic jets in this region. In this embodiment, jets 2110 are actuated to provide a flow from slots 2111, which opposes the flow entering the duct 2100 at the leading edge region 2120. The flow can emanate from slots 2111 at any direction into the flow entering the duct and particular angles may be desired over others for particular applications. In this embodiment, the flow from the jets 2110 interacts with the flow entering the duct at about a 45 degree angle with respect to the leading edge surface and/or the flow flowing into the duct. As shown, less duct lift can be caused by separation induced at the leading edge, which can be used to decrease the pitching moment experienced during wind gusts and could reduce the amount of flight control actuator usage to maintain stable flight.

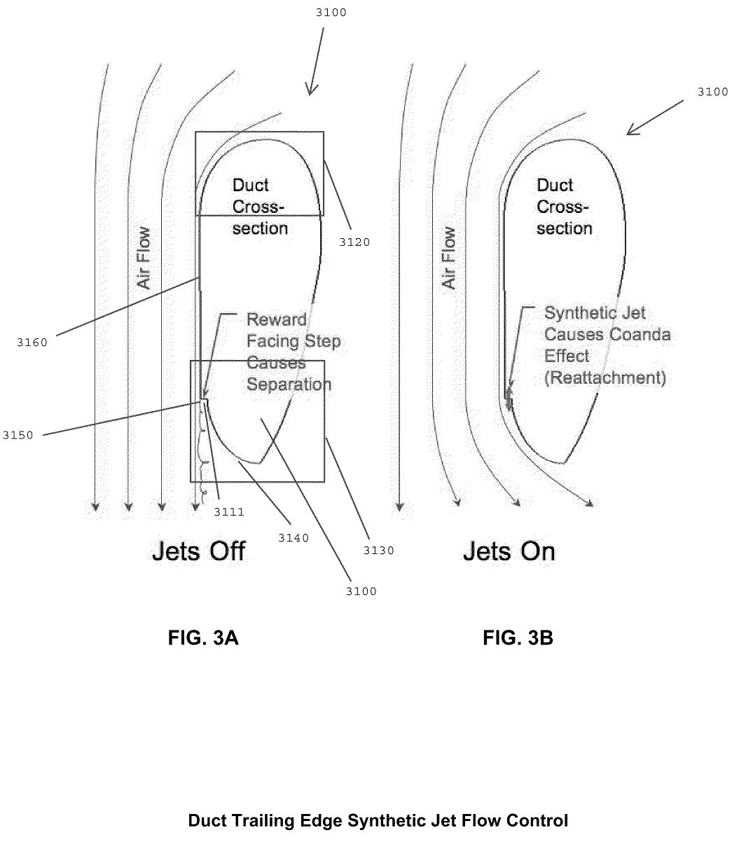

FIGS. 3A and 3B show a schematic of manipulating flow in the vicinity of the trailing edge of a duct by employing blowing techniques. In FIGS. 3A and 3B, a flow is shown (by arrows) flowing through duct 3100 from the leading edge region 3120 to the trailing edge region 3130 where it exits the duct. Here, the trailing edge region includes a Coanda surface geometry 3140 with a bluff step 3150. As shown in FIG. 3B, flow, when caused to emanate from the step 3150 (i.e., synthetic or steady jets on), can cause the flow flowing through the duct to stay attached to the Coanda surface 3140, thereby causing the primary flow out of the duct to turn. In this embodiment and as shown in FIG. 3A, flow produced by jets emerges from slots 3111 tangential to the inner surface of the duct 3160. This results in a normal force opposite to the turned flow and a corresponding moment about the vehicle CG. When the jets are turned off the flow leaving the duct 3100 separates off the bluff corner 3150 and proceeds straight out of the duct. This technique, attachment of flow by way of a Coanda surface and using the Coanda effect in combination with blowing at the trailing edge, can be used to create normal force and reduce pitching moment.

The use of leading and/or trailing edge flow control techniques as just described can be applied asymmetrically to the duct in order to produce an imbalance in forces, thus resulting in a moment. The net force and moment caused by the asymmetric flow control could be used to control or augment the motion of a ducted-fan vehicle. The target condition for affecting pitching moment is trimmed horizontal flight at 35 ft/s free-stream velocity with −20° angle of attack (tilt into the wind).

Synthetic Jet Component Design.

A component development effort was undertaken to design and bench test synthetic jet actuators based on flight-size piezoelectric elements to identify anticipated jet velocities for vehicle wind tunnel testing. See, Osgar John Ohanian III; Etan D. Karni; W. Kelly Londenberg; Paul A. Gelhausen; and Daniel J. Inman; “Ducted-Fan Force and Moment Control via Steady and Synthetic Jets,” 27^{th} AIAA Applied Aerodynamics Conference, Jun. 22-25, 2009, San Antonio, Tex., which is hereby incorporated by reference in its entirety.

One objective of these tests was to quantify the expected jet velocities for a laterally oriented (jet parallel to diaphragm) rectangular slot with orifice area more than ten times greater. A long slot orifice is more applicable to the tangential flow control concepts investigated for the ducted fan application. Peak jet velocities of about 200 to about 225 ft/sec were attained with slot and cavity geometry and orientation similar to the anticipated application. Further, shallower cavity depths were desirable from a jet performance standpoint, but this fact also aids in packaging such actuators in a vehicle with limited volume for components.

Preferred are jets with rectangular slots, or curved to follow the circumference of the leading edge or Coanda surface. Specific dimensions include slots having a width ranging from about 0.2% to about 0.5% of the duct inside diameter, and a length ranging from about 5% to about 8% of the duct inside diameter; with a cavity having a diameter ranging from about 8% to about 10% of the duct inside diameter, and a width ranging from about 5% to about 8% of the cavity diameter; and an orifice having a depth of about 10% of the cavity diameter, a width ranging from about 0.2% to about 0.5% of the duct inside diameter, and a length ranging from about 5% to about 8% of the duct inside diameter.

Of particular interest is a synthetic jet geometry, wherein the slots are rectangular and have a width ranging from about 0.02 inches to about 0.04 inches and a length ranging from about 0.8 inches to about 0.95 inches; wherein the orifices have a depth of about 0.1 inch, a width ranging from about 0.02 inches to about 0.04 inches, and a length ranging from about 0.8 inches to about 0.95 inches; and wherein the cavities have a diameter of about 1 inch, a width ranging from about 0.05 inches to about 0.08 inches, and a volume ranging from about 0.03 cubic inches to about 0.07 cubic inches. Of particular interest were jets having a slot width of about 0.030 inches.

Synthetic Jets and Vehicle Integration.

Integrating synthetic jet components in a ducted-fan vehicle is not straightforward and involves consideration of numerous factors. One of the challenges in developing the wind tunnel vehicle model was the integration of the piezoelectric diaphragm elements. Three main criteria drove the design of the wind tunnel model SJA installation. These were: (1) minimize lateral spacing between SJA, to more closely approximate a uniform jet along the entire circumference of the duct; (2) provide consistent clamping loads for each SJA, to improve boundary condition uniformity; (3) securely but non-permanently install the piezoelectric diaphragms in the model. This is necessary to minimize downtime from any failures encountered during the wind tunnel test.

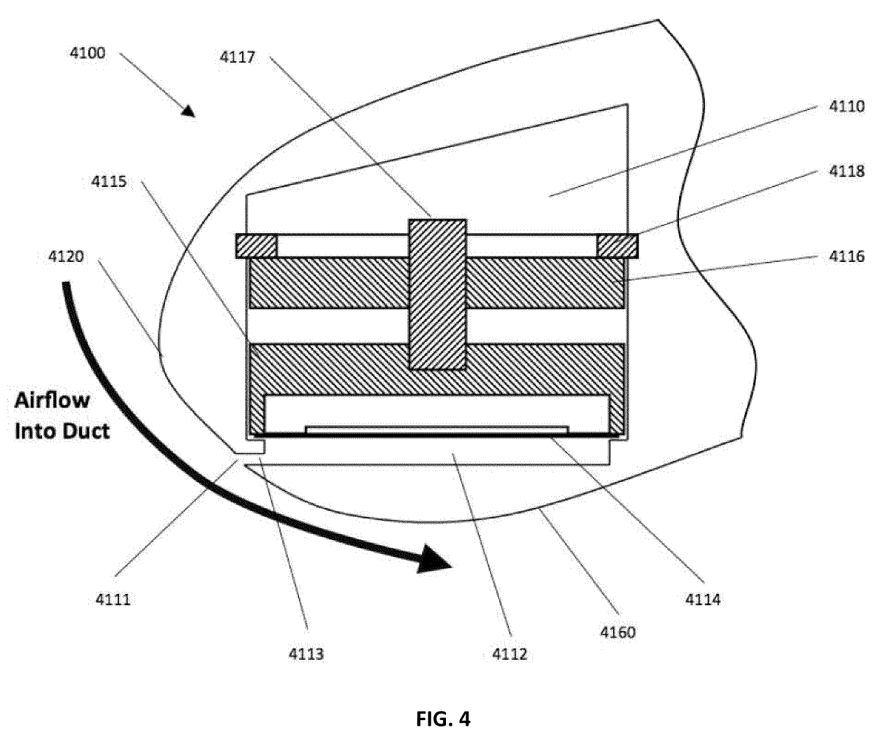

Preferred embodiments are shown in FIGS. 4-7, which show synthetic jets and slot orientations for a leading edge surface and trailing edge region of ducted fans, in particular, jets employing an axial screw clamp. While this embodiment uses slightly more parts than other options, it allows for simple replacement of elements, has excellent adjustability, and yields minimum lateral spacing between SJA thereby increasing the coverage of the duct circumference. For a flight implementation, the piezoelectric elements would be directly bonded into the cavity to minimize volume and weight. Additionally, for a flight vehicle the clamping hardware could be eliminated and the piezoelectric discs could be bonded in place using epoxy or a comparable bonding agent, thus minimizing weight and volume to implement the synthetic jet implementation.

FIG. 4 shows one embodiment for integrating synthetic jets into the leading edge surface of a ducted fan. In this figure, during operation airflow enters the interior of the duct 4100 along or in the vicinity of inner duct wall or surface 4160 to interact with the fan (not shown). The outer duct wall or outer surface of the duct is shown toward the top of the figure. In this embodiment, duct 4100 comprises jet 4110 under the surface of the duct. One or more jets 4110 can be incorporated around the circumference of the leading edge surface 4120 of the duct. Operably associated with each jet 4110 is cavity 4112, orifice 4113, and slot 4111. During operation of jet 4110, a flow is produced by diaphragm 4114, which vibrates to introduce a flow to air or gas contained in cavity 4112. This flow is pushed out of cavity 4112 through orifice 4113 and emerges from slot 4111 in the leading edge of the duct.

The internal parts of the wind tunnel model that housed the piezoelectric diaphragms were machined aluminum, with bored holes to hold the elements. A compression cup 4115 presses down on the edge of the piezoelectric diaphragm 4114 to apply a uniform clamping load. A tapped disc 4116 with setscrew 4117 is then inserted, with a retention ring 4118 finally snapping into place to support the tapped disc 4116. The setscrew 4117 is advanced to push on the compression cup 4115 and apply the necessary clamp load uniformly to the diaphragm 4114 edge. The added benefit of this approach was that a single input (screw torque) was used to tune the boundary condition for the piezoelectric elements.

In the embodiment shown in FIG. 4, jet orifice 4113 is oriented at roughly 45° relative to the leading edge surface 4120 to oppose the flow entering the duct at roughly 45°. Different angles of orientation of the orifices 4113 with respect to the leading edge surface 4120 may be used depending on particular applications. Indeed, the orifice 4113 can be oriented at any angle, for example, to provide a desired flow anywhere from normal to tangential with respect to the leading edge 4120.

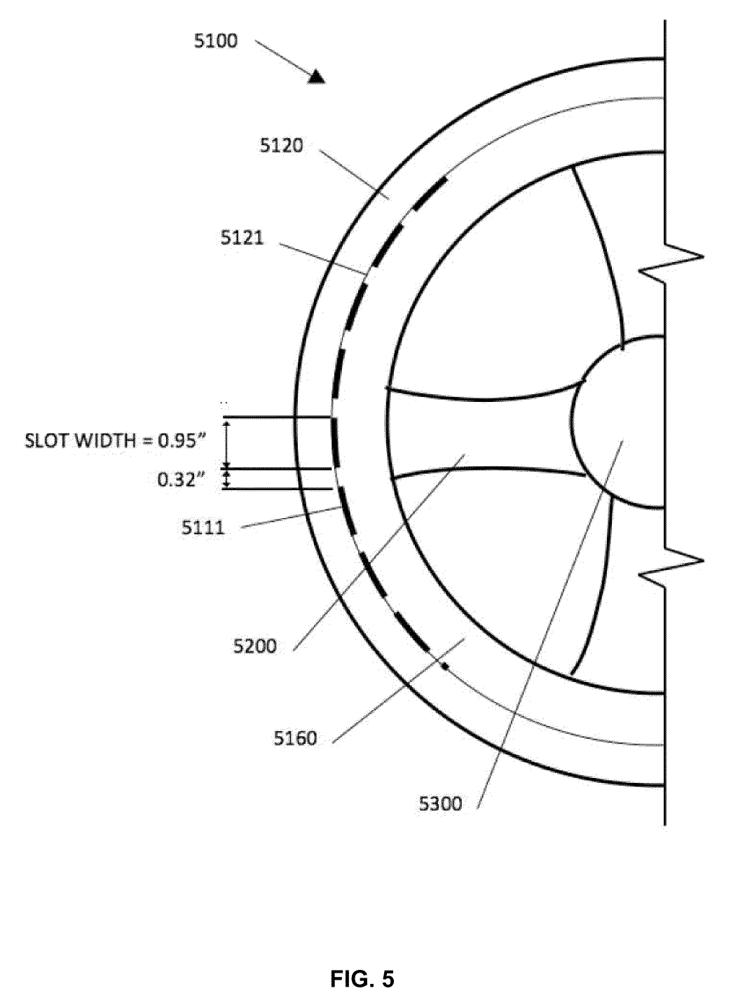

FIG. 5 shows one embodiment of slot geometry and orientation around the surface of the leading edge, which may be used according to the invention. As shown, duct 5100 can comprise leading edge surface or region 5120. On the leading edge surface 5120 can be identified a circumference 5121 around which slots 5111 lie. For perspective, also shown are center body 5300, fan 5200 and inner duct surface 5160.

In this embodiment, the coverage of the duct lip attained for the leading edge blowing is 75%, as can be seen in FIG. 5. As shown, the width of slots 5111 is 0.95 inches and the spacing between the slots is 0.32 inches for this diameter of the leading edge surface of the duct. Slot width and orientation around the leading edge surface may be varied for particular applications. One or more slots 5111 can be used at the leading edge surface 5120 to obtain a desired coverage of circumference 5121 needed for a particular application. For example, a single slot 5111, which covers 100% of the circumference 5121 of the leading edge, may be desired. Further, more than one or multiple slots 5111 spaced around circumference 5121 may alternatively be desired. The number and spacing of slots 5111 is not critical and it is within the skill of the art to select an appropriate number and spacing of slots 5111 for particular applications. Any amount of circumference 5121 can be consumed by slots 5111 for 0-100% coverage.

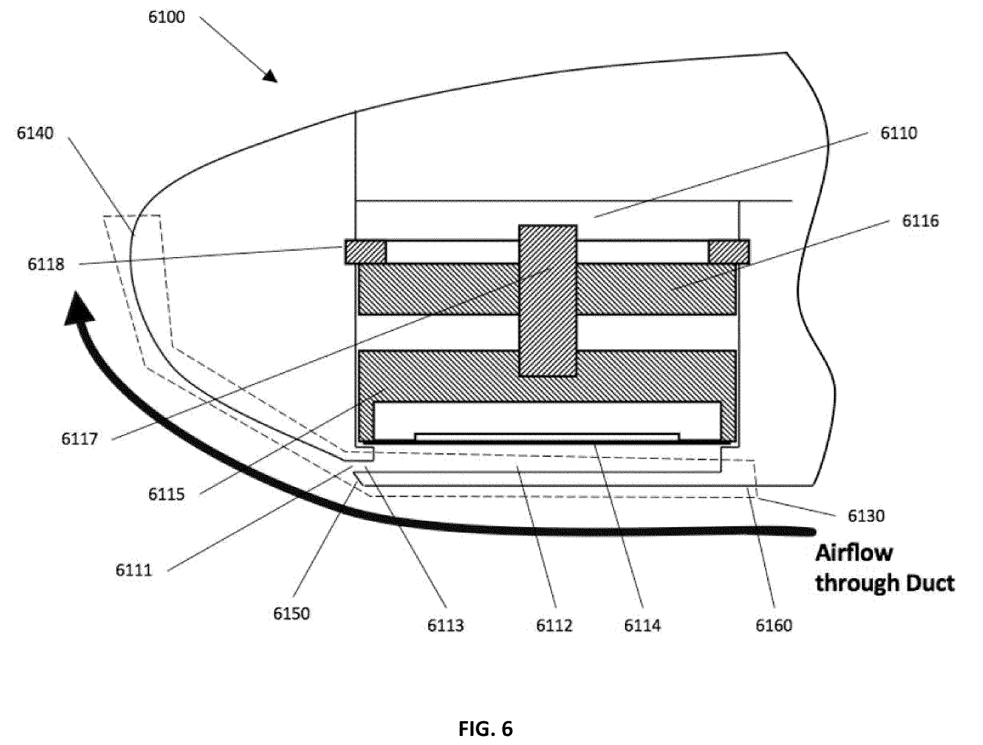

FIG. 6 shows one embodiment of how synthetic jets can be integrated into the trailing edge region of a ducted fan 6100. Similar to the geometry of the leading edge surface, the geometry of the trailing edge region for holding the piezoelectric elements can be identical except for the surrounding Coanda geometry. As shown in FIG. 6, the geometry of the trailing edge region 6130 can be configured so as to align the jet orifice 6113 tangential to the Coanda surface 6140 to blow approximately in the same direction as the flow through the duct during operation. Here, a bluff step 6150 is introduced to transition between the inner duct surface 6160 and the Coanda surface 6140 in the trailing edge region 6130.

To minimize the travel from the cavity 6112 to the orifice opening 6111 (jet slot) the jet cavity 6112 can be positioned parallel to the duct inside wall 6160 (towards the bottom of the figure), i.e., the inner surface of the duct. In this embodiment, the internal features to hold the piezoelectric elements are identical to that described with respect to the leading edge geometry, including with respect to the jet 6110, retention ring 6118, set screw 6117, compression cup 6115, tapped disc 6116, and the piezo driver 6114 (diaphragm).

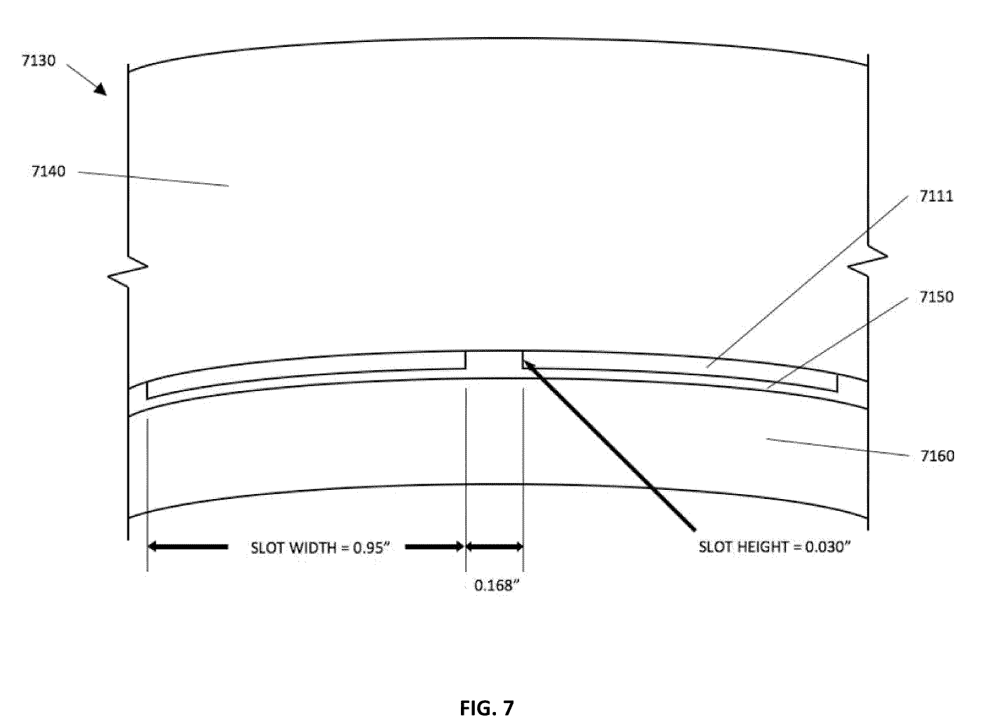

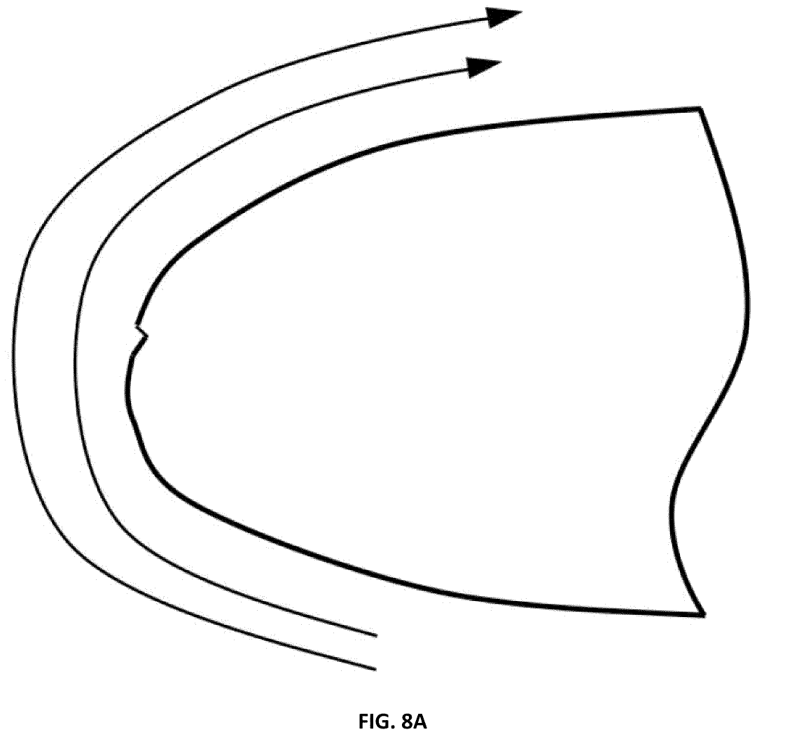

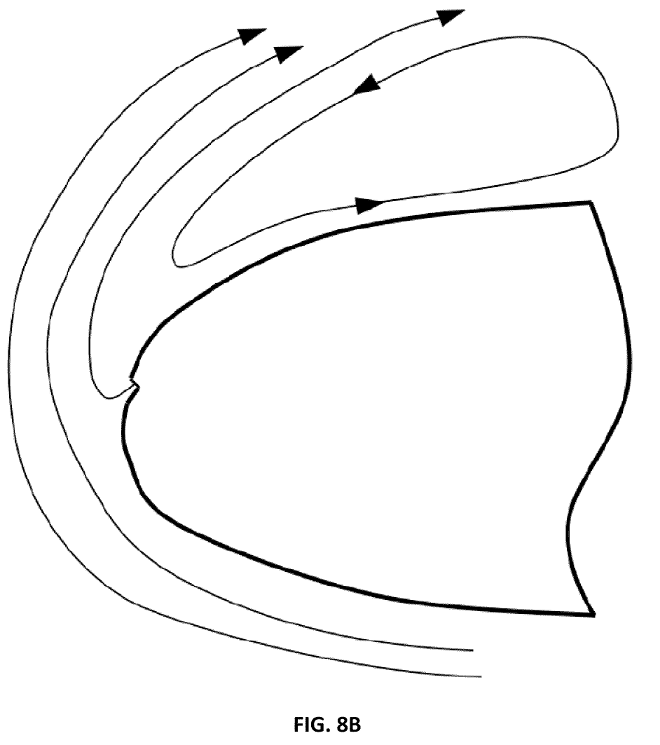

FIG. 7 shows one embodiment of slot geometry and orientation around the surface of the trailing edge region 7130 of a duct, which may be used according to the invention. The trailing edge region 7130 in this embodiment comprises an inner duct surface 7160, a bluff step 7150, and Coanda surface 7140. During operation, flow will pass through the duct in the vicinity of the inner duct surface 7160, then over the bluff step 7150 and into the Coanda surface region 7140. Here, multiple slots 7150 are shown around a circumference of the Coanda surface 7140 and have a slot width of about 0.95 inches and spacing between slots of about 0.168 inches. This corresponds with circumferential coverage of the Coanda circumference of about 85%. Any amount of coverage of the circumference of the Coanda surface can be used and it is within the skill of the art to select optimal slot widths and spacing for a particular application. For example, coverage from 0-100% of the Coanda circumference would be appropriate, including from about 0-25%, 20-33%, 10-50%, 40-75%, 60-80%, and 70-100% of the Coanda surface circumference.

Computational Results.

An embodiment of the synthetic jet actuator design described above was integrated into the vehicle geometry and 3D time-accurate (unsteady) computational fluid dynamics (CFD) was used to assess the predicted performance and improve the integrated design before fabricating the model geometry. The effect of steady and synthetic jet blowing on the ducted fan configuration was analyzed using the NASA Langley FUN3D Reynolds-averaged Navier-Stokes, unstructured mesh method Anderson, W. K. and Bonhaus, D. L., “An Implicit Upwind Algorithm for Computing Turbulent Flows on Unstructured Grids,” Computers and Fluids, Vol. 23, No. 1, 1994, pp. 1-22. Incompressible solutions were obtained for the ducted fan configuration at 15-knots and 14.33° tilt from vertical (−14.33° angle of attack). In each of the CFD solutions, the fan was simulated as an actuator disk, using the rotor method integrated with the FUN3D solver. See, O'Brien, D., Analysis of Computational Modeling Techniques for Complete Rotorcraft Configurations, Ph.D. thesis, Georgia Institute of Technology, 2006.

Using blade geometry and airfoil aerodynamics, this actuator disk method iterates the swirl and pressure increase due to the fan with the computed inflow, resulting in a good simulation of first order fan effects. Steady and unsteady blowing conditions were applied as velocity boundary condition at the orifice.

### Example I

### Leading Edge Blowing Analysis

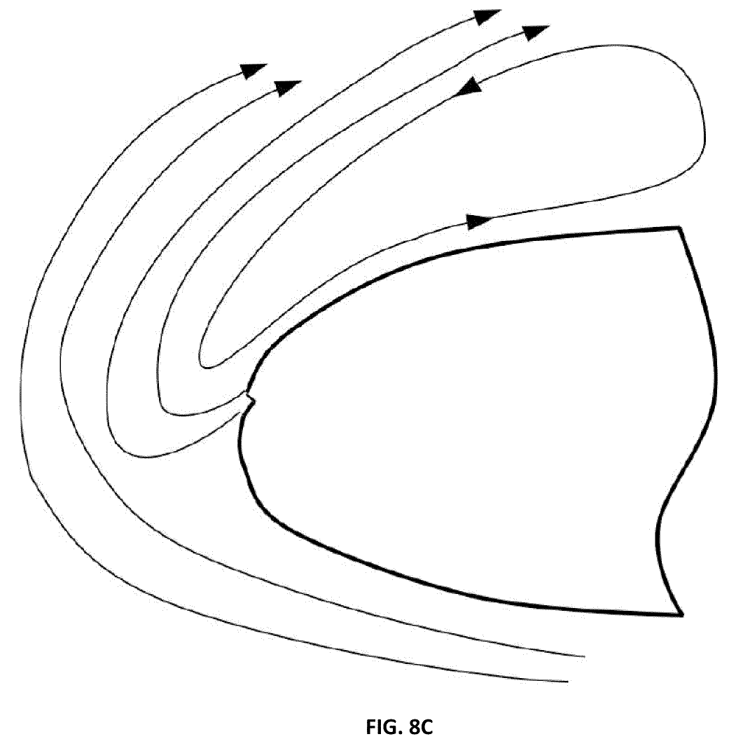

FIG. 8A-C provide a visual representation of a flow entering a ducted fan with respectively no blowing of jets, 100-ft/sec blowing, and 200-ft/sec blowing at the leading edge surface of a ducted fan. For these analyses, the blowing boundary condition was applied at the exit face of the slot. This reduced order modeling allowed for solution convergence. Comparing the 100-ft/sec and 200-ft/sec blowing with the no blowing case, FIGS. 8A-C show that leading-edge blowing separates the flow over the lip. When the blowing is not present, the flow proceeds into the duct smoothly. As blowing velocity is increased, the core of the separated region is lifted farther off the surface. Also, as blowing velocity is increased, the effect on the vehicle pitching moment is increased. The 50-ft/sec blowing velocity reduced the no blowing configuration pitching moment by more than a third, 100-ft/sec blowing reducing it by half, and 200-ft/sec blowing reducing the no-blowing pitching moment by two-thirds. An interesting observation is that the difference in pitching moment between full (360 degree) circumferential blowing and windward blowing (front 180 deg of duct circumference) was minimal, implying that the majority of the effect on the flow is occurring at the windward lip. Blowing over the leeward half alone produced little effect.

### Example II

### Coanda Trailing Edge Blowing Analysis

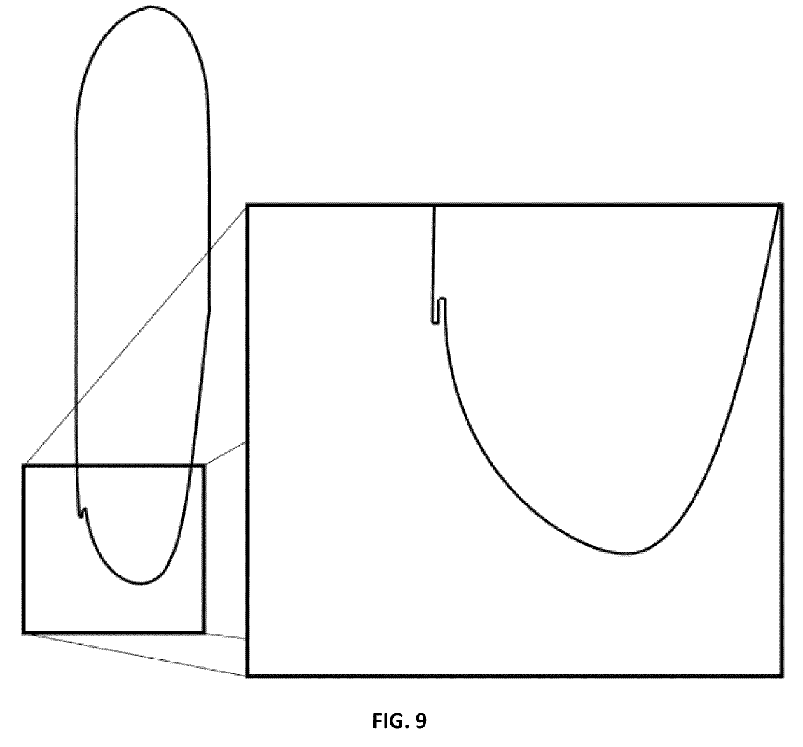

FIG. 9 shows a cross-sectional view of a duct, emphasizing trailing edge geometry of an embodiment of the invention. In this embodiment, a trailing edge geometry was developed for a 0.03 inch slot width and Coanda surface. In initial steadystate analyses, the jet velocity was imposed at the slot exit plane, i.e., the internal slot geometry was not modeled. In these cases, the internal orifice geometry was modeled with the sinusoidal velocity boundary condition applied at the beginning of the orifice neck. Steady blowing over the windward trailing edge at 200 ft/sec resulted in a normal force and decreased the pitching moment. Although the expansion of the streamtube resulted in an expected loss of thrust, power required by the fan also decreased.

Jet velocity was modeled as a time varying sinusoidal function. The 2400-Hz, ±200-ft/sec normal sinusoidal velocity boundary condition (values taken from bench test performance) was modeled over 100 computational time steps. It was also determined that little difference in pitching moment was obtained between blowing over half of the trailing-edge circumference and a quarter of the trailing-edge circumference, centered about the windward edge. Due to the obvious fabrication benefits of instrumenting only a quarter of the duct trailing edge versus half of the circumference, many of the analyses were conducted for the quarter blowing geometry.

Initial unsteady results exhibited a region of significant flow separation on the Coanda surface. In these analyses, the slot geometry was modeled with an edge normal to the flow inside the duct. In one embodiment, the thin wall between the jet throat and the duct flow had square corners. The sharp corner, however, may make it difficult to attain attachment on the Coanda surface. Alternatively, the thin wall geometry can be modified to round the corner closest to the duct flow.

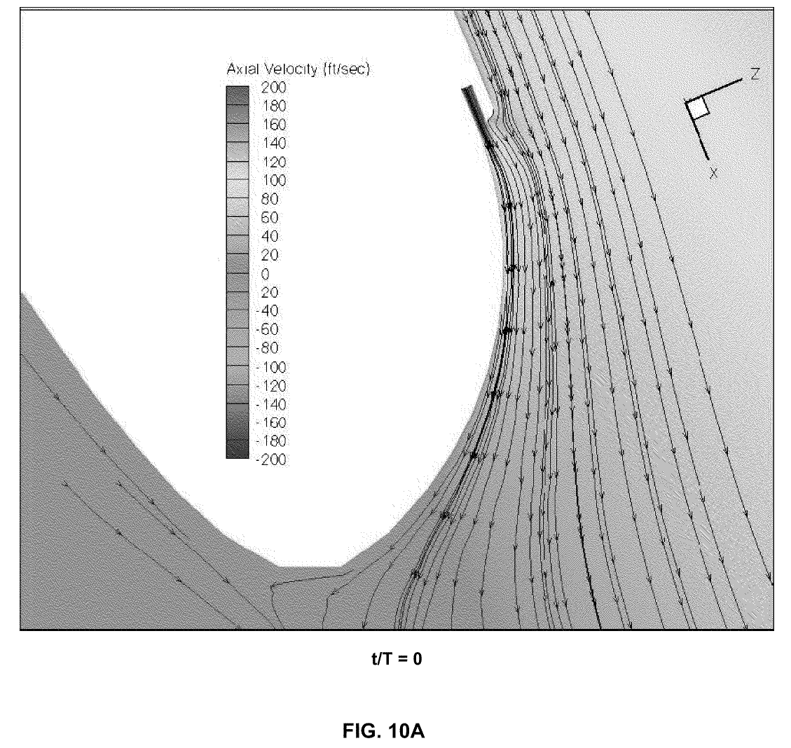

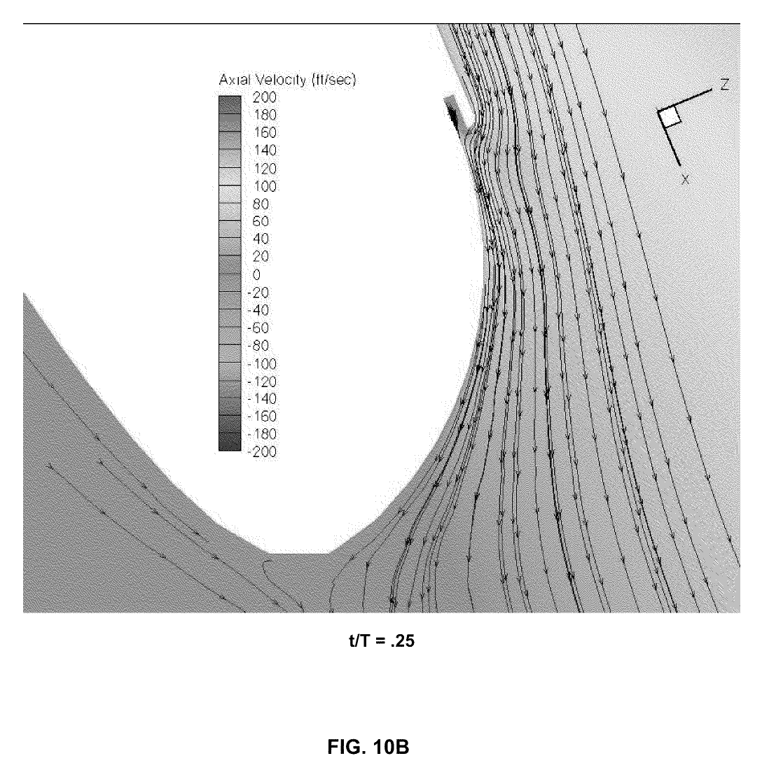

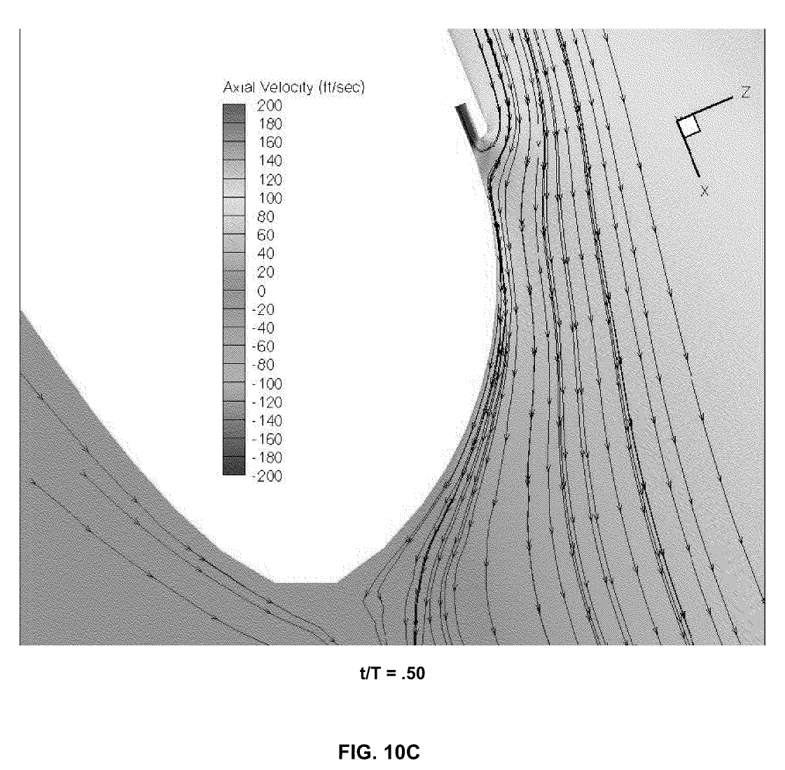

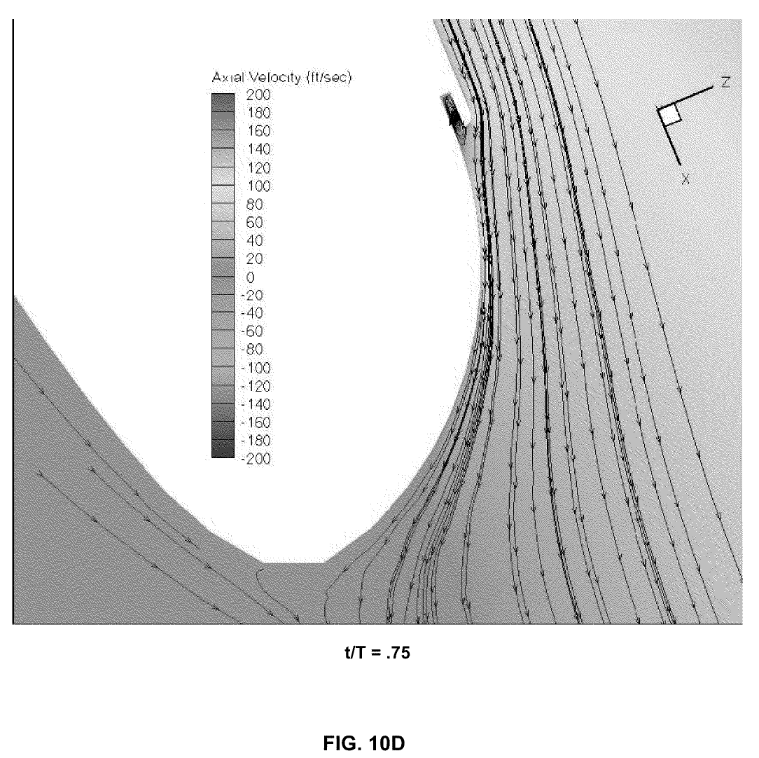

FIGS. 10A-D provide the results of analysis of trailing edge blowing with a rounded bluff step geometry. The flow with this geometry remains attached along more of the Coanda surface curvature. More particularly, the red color in the jet orifice corresponds to the outstroke of the synthetic jet (t/T=0) and the blue denotes the instroke or suction phase of the synthetic jet (t/T=50). The slug of flow that is pushed out during one cycle of the synthetic jet can be observed in subsequent frames (the warm colors moving down the Coanda surface), and is still observable at t/T=75 close to the time of the next outstroke. With flow remaining attached to the Coanda surface, the streamtube is expanded and turned, with a corresponding normal force and reduction in pitching moment. Accordingly, the rounded corner design was chosen for wind tunnel experiments and the CFD analysis was helpful in refining the flow control geometry as preparation for wind tunnel experiments.

### Example III

### Wind Tunnel Tests

Static (hover) tests were performed in a high bay area and wind tunnel tests were performed in the Virginia Tech 6 ft×6 ft Stability Wind Tunnel. The vehicle model was fabricated from machined aluminum and nylon as well as rapid prototyped resin parts. The model was supported by a 6-component force and moment balance in a side mount orientation to align the most sensitive channel of the balance with the vehicle's pitching moment axis (y-axis). Pitch sweeps were executed by rotating the wind tunnel turntable on which the balance is mounted, with the direction of flight in the positive x-direction (when angle of attack is zero).

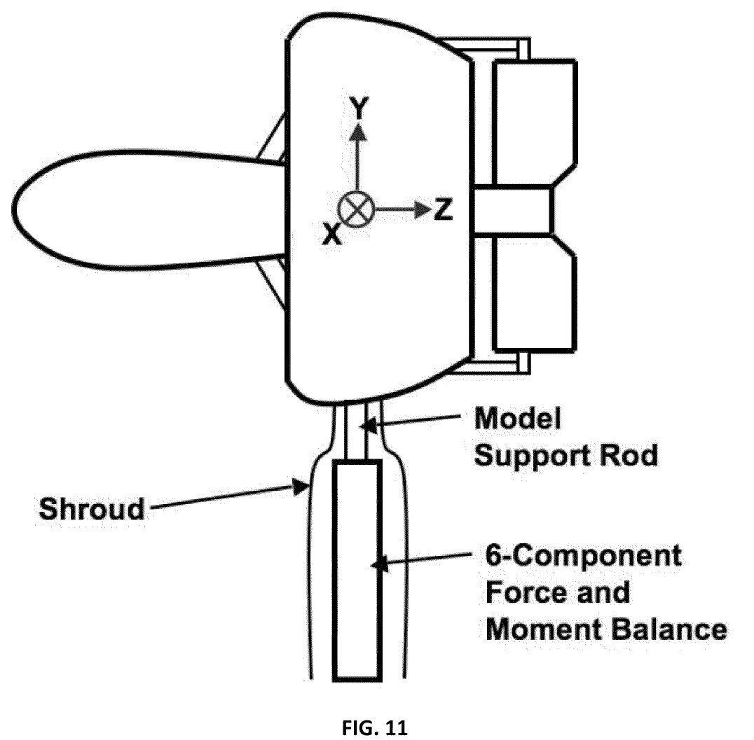

FIG. 11 provides an illustration of the balance and vehicle used for the wind tunnel testing, along with the coordinate system used for collecting data. The data presented herein was transformed to move the moment reference center to the center of the duct lip as a simple datum for the vehicle design.

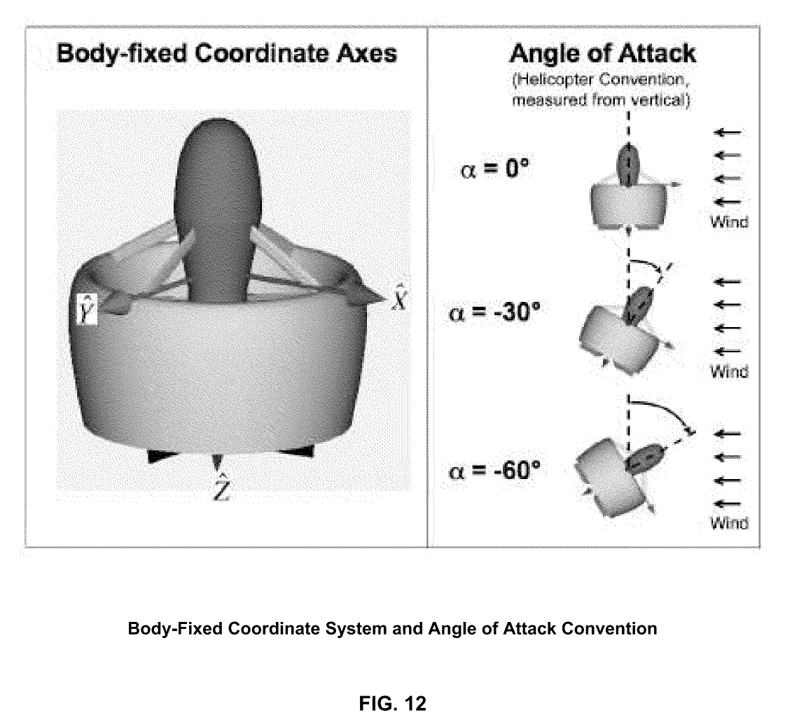

FIG. 12 illustrates this coordinate system along with the angle of attack convention (similar to a helicopter). In this coordinate system the vehicle thrust results in a negative FZ force, a traditional normal force corresponds to a negative FX force, and a nose-up moment is a positive MY moment.

Multiple configurations of the vehicle model were used to explore the effects of the synthetic jets as well as steady blowing using a compressed air supply. Synthetic jet velocities in the vehicle slots were measured statically with the hotwire anemometry as described above. The trailing edge peak velocities were comparable to bench test results (˜200 ft/s), but leading edge peak velocities were roughly 60% of the bench test values. This was attributed to the orifice depth being longer (due to manufacturing constraints) and the increased losses resulted in a lower jet output and damped natural frequency.

The optimum drive frequency for trailing edge actuation was 2300 Hz and for leading edge actuation was 1900 Hz. Steady blowing velocities were set using a mass flow meter. Steady blowing velocities included 164 ft/s, 311 ft/s, and 509 ft/s.

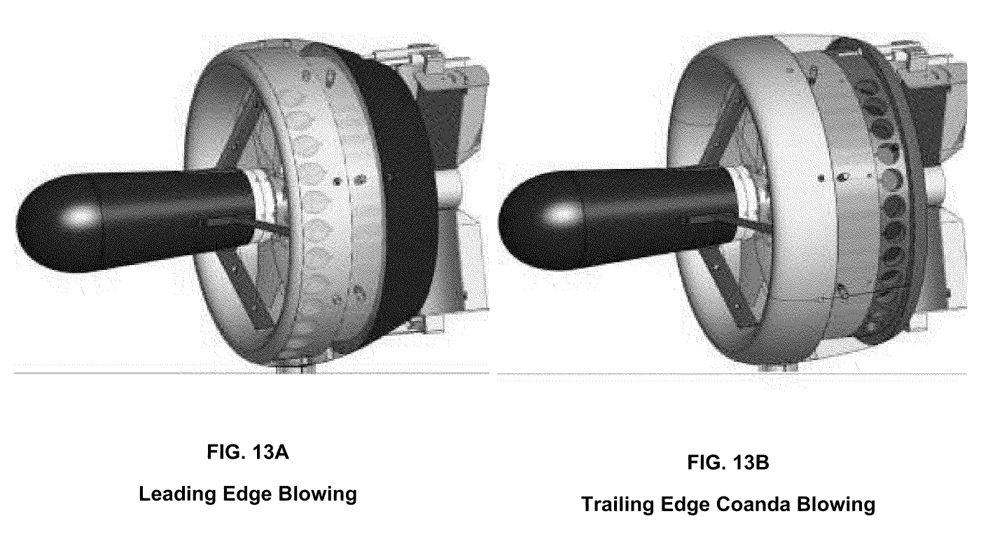

FIGS. 13A-B show respectively leading edge and trailing edge blowing configurations used to quantify the effectiveness of SJAs. As shown, only eight of the slots were employed in tests, accounting for one quarter of the duct circumference.

The model was constructed in a modular fashion such that various control surfaces, duct lips and trailing edges could be tested using the same apparatus. The model was installed in the Virginia Tech Stability Wind Tunnel. The balance and stand rotate on a turntable, so the vehicle is mounted on its side to be able to evaluate a pitch sweep via turntable rotation.

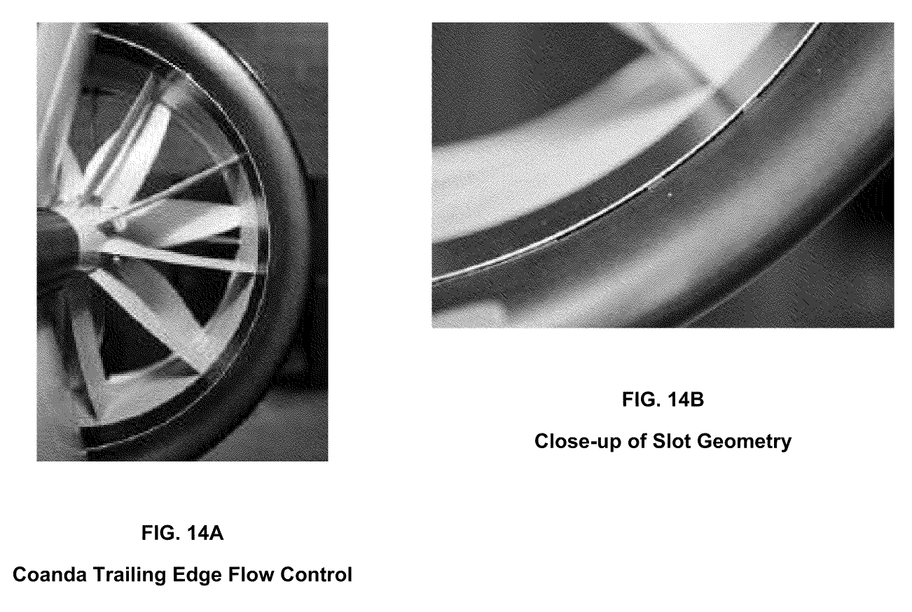

FIGS. 14A-B show an embodiment of a Coanda trailing edge component installed on a vehicle, with a close-up view of the curved 0.030″ slot geometry. In this embodiment, the leading edge and trailing edge flow control components were both machined from aluminum, and EDM (electrical discharge machining) was employed to obtain precise slot geometry. Finally the components were anodized to electrically isolate the piezoelectric components from the rest of the model.

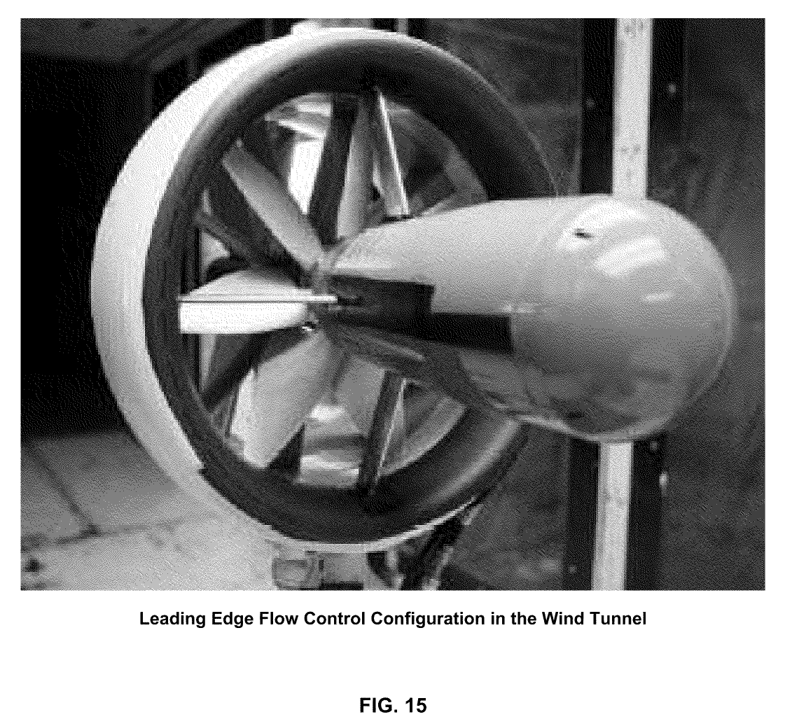

FIG. 15 shows the leading edge flow control duct lip installed in a ducted-fan vehicle. The airflow over the duct naturally comes from the outside toward the fan. The slots are oriented to point outward such that when blowing is actuated the flow over the lip could be caused to separate on demand.

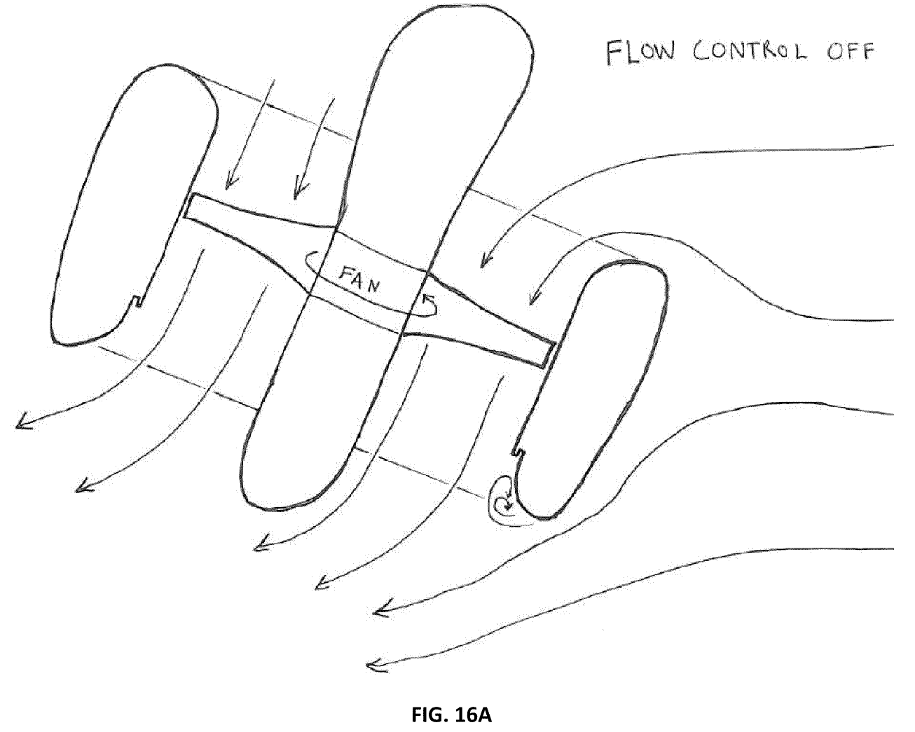

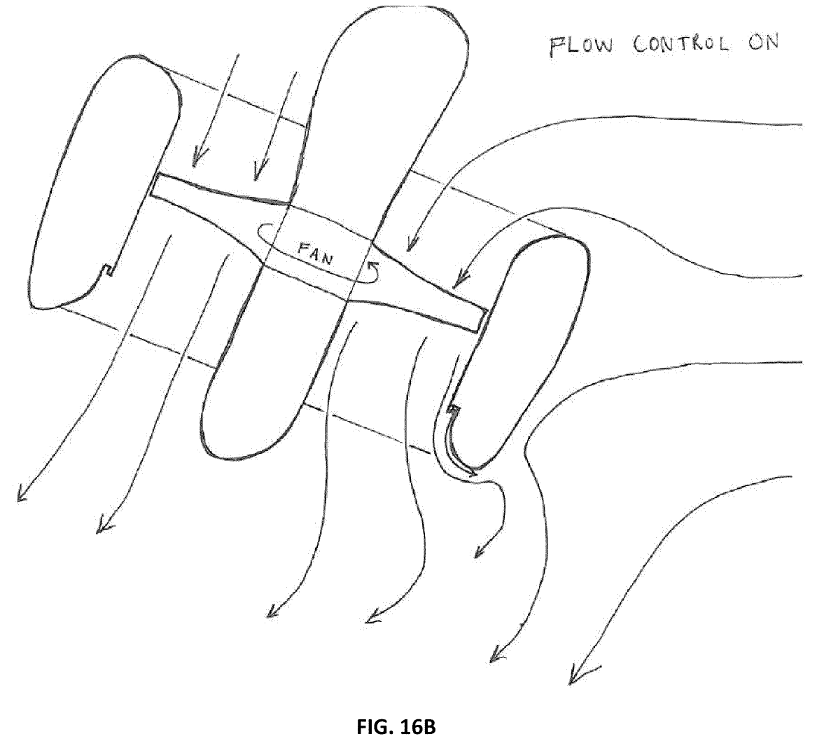

FIGS. 16A-B show a rear perspective view of a ducted-fan vehicle during operation (Coanda trailing edge blowing at lower flight speeds and high blowing velocities) with flow through the duct separated or attached to the Coanda surface depending on whether jet flow control is off or on. In addition to collecting data from the force and moment balance, flow visualization was captured by video, which is instructive to an understanding of the overall phenomenon occurring. Two still frames from the video are shown in FIGS. 16A-B for a 35 ft/sec free-stream flow, with the vehicle tilted 20 degrees into the wind.

As shown in FIG. 16A, the Coanda blowing is turned off and the tufts on the Coanda surface are fluttering and imply separated flow. Also the tuft wand in the duct exit flow (“stream tube”) is being greatly influenced by the free-stream flow coming from the right, and is bending past the lower centerbody. As shown in FIG. 16B, the highest steady blowing rate is in effect and the tufts on the Coanda surface are fully attached. This flow causes the whole stream tube to expand and turn upstream, as can be noted from the large angular change in the tuft wand.

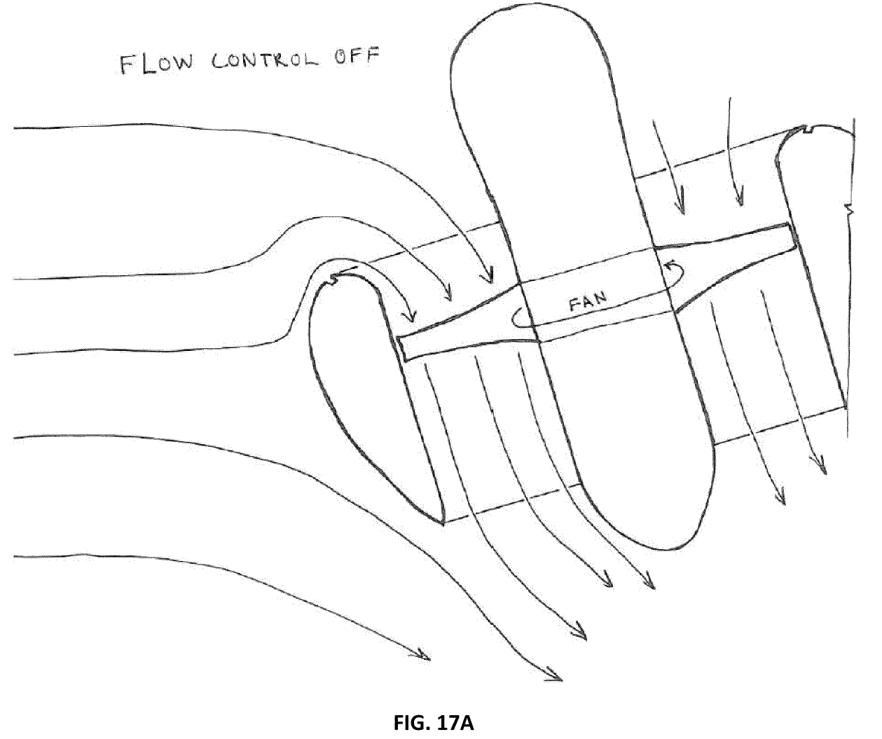

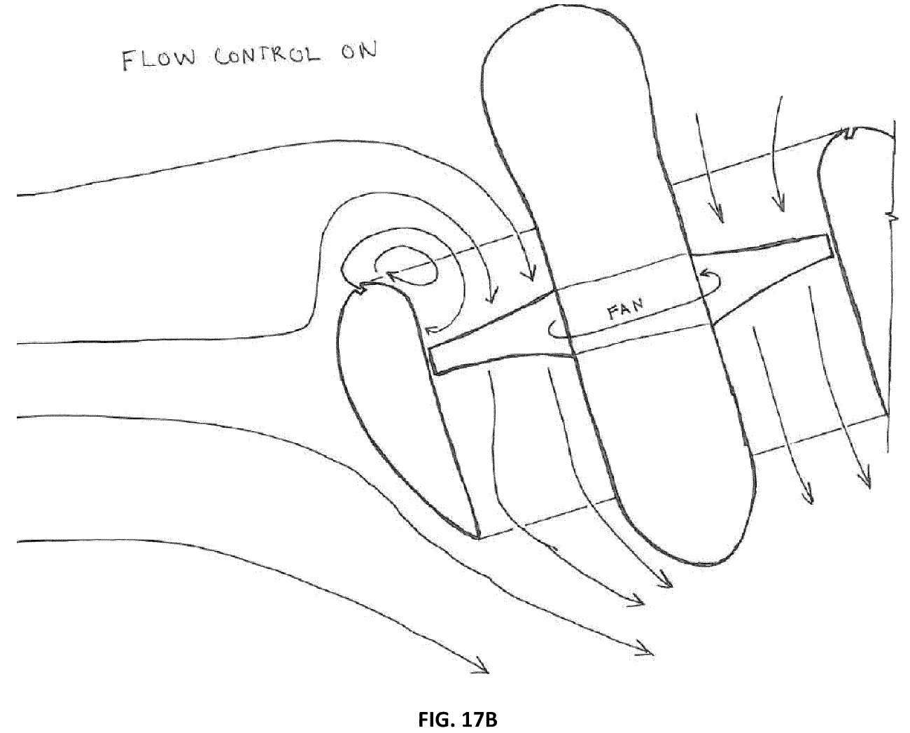

FIGS. 17A and 17B show visualization for leading edge flow control for a 35 ft/s free-stream flow at an angle of attack of −20 deg. The leading edge flow control was ineffective at static conditions, but did produce the intended effect at 35 ft/s free stream airflow and an angle of attack consistent with equilibrium flight conditions.

The leading edge flow control has the opposite effect as compared to the trailing edge: when turned off (FIG. 17A), the lip is fully attached, but when actuated (FIG. 17B), full flow separation is caused. When the flow is attached the thrust gained by the suction results in a nose-up pitching moment. When the flow is separated there is a loss of thrust and a decrease in pitching moment. While a loss of thrust sounds disadvantageous, a cross wind in hover can cause increased lift on the vehicle causing it to rise. If the vehicle is trying to maintain a fixed altitude, this ability to cancel the added lift from the cross wind through high bandwidth actuation could be desirable.

In summary, the flow visualization results show that both flow control techniques can significantly affect the flow at high blowing levels.

### Example IV

### Non-dimensional Approach for Flow Control Data

Ducted fan vehicles present a unique problem for formulating non-dimensional coefficients for blowing momentum and vehicle forces and moments. Because the free-stream dynamic pressure used in most approaches goes to zero when the vehicle is hovering, a different approach is needed.

An approach that can span hover to forward flight is optimal, and therefore must be based on some common parameter to both regimes. The fan tip speed or the flow induced through the duct are possible candidates. For vehicle forces and moments, the form typically used for propeller thrust coefficient will be applied to the normal and axial forces as well as the pitching moment. These are represented in Equations (5) through (7), respectively.

$$\begin{matrix}{C}_{X} = \frac{{F}_{X}}{ρ {N}^{2} {D}^{4}} & ( 5 ) \\ {C}_{Z} = \frac{{F}_{Z}}{ρ {N}^{2} {D}^{4}} & ( 6 ) \\ {C}_{m} = \frac{{M}_{Y}}{ρ {N}^{2} {D}^{5}} & ( 7 )\end{matrix}$$

where ρ is the air density, N is the rotational speed of the fan in revolutions per second, and D is the fan diameter.

The blowing momentum coefficient typically used for fixed-wing flow control analysis (see Englar, R. J., “Overview of Circulation Control Pneumatic Aerodynamics: Blown Force and Moment Augmentation and Modification as Applied Primarily to Fixed-Wing Aircraft,” Chapter 2, Applications of Circulation Control Technology, American Institute of Aeronautics and Astronautics, Reston, Va., 2006) is:

$${c}_{μ} = \frac{{\dot{m}}_{j} {U}_{j}}{{q}_{∞} S} \qquad ( 8 )$$

where \dot{m}ⱼ is the jet mass flow, Uⱼ is the jet speed, q_{∞} is the free-stream dynamic pressure, and S is the wing planform area.

Other researchers have used the fan tip speed to non-dimensionalize the blowing momentum coefficient for the ducted fan application. See Kondor, S.; W. Lee; R. Englar; M. Moore, “Experimental Investigation of Circulation Control on a Shrouded Fan,” Paper AIAA-2003-3409. Proceedings, 33rd Fluid Dynamics Conference, Jun. 23-26, 2003, Orlando, Fla. While the fan tip speed offers a consistent way to normalize the data, it can be several times higher than the induced flow interacting with the flow control jets.

To be more comparable to jet momentum coefficients for other applications, the speed of the flow inside the duct was chosen as a better reference for nondimensional analysis. The flow induced through a ducted fan can be calculated from momentum theory (as noted in Kondor. S.; M. Heiges, “Active Flow Control For Control of Ducted Rotor Systems”, AIAA Paper 2001-117, Proceedings, 39th AIAA Aerospace Sciences Meeting & Exhibit, Jan. 8-11, 2001, Reno, Nev., 2001) to be:

$${V}_{induced} = \sqrt{\frac{T}{ρ {A}_{disc}}} \qquad ( 9 )$$

where T is the thrust, and A_{disc} is the area of the fan. The steady blowing momentum coefficient based upon the dynamic pressure of the induced flow then becomes:

$${c}_{μ} = \frac{{\dot{m}}_{j} {U}_{j }}{{q}_{duct} {A}_{duct}} , {q}_{duct} = \frac{1}{2} ρ {V}_{induced}^{2} \qquad ( 10 )$$

where A_{duct} is the projected area of the duct (diameter times chord) to be comparable with the planform area of a wing.

The synthetic jet oscillatory flow requires special treatment in deriving the equivalent blowing momentum coefficient. Farnsworth et. al. (see Farnsworth, J. A. N., J. C. Vaccaro, and M. Amitay, “Active Flow Control at Low Angles of Attack: Stingray Unmanned Aerial Vehicle,” AIAA Journal, Vol. 46, No. 10, October 2008, pp. 2530-2544) have used a blowing momentum coefficient based on the total time-averaged momentum of the outstroke, Īⱼ, defined as:

$${\overline{I}}_{j} = \frac{1}{τ} ρ {l}_{j} {w}_{j} {\int }_{0}^{τ} {u}_{j}^{2} ( t ) d t \qquad ( 11 )$$

where τ is the outstroke time (half the overall period), lⱼ is the slot length, wⱼ is the slot width, and uⱼ is the centerline velocity of the jet, as used in the definition for U₀. Multiplying this value by the total number of jets to get the total momentum imparted and dividing by the induced dynamic pressure and area yields a comparable blowing momentum coefficient:

$${c}_{μ} = \frac{n {\overline{I}}_{j}}{{q}_{duct} {A}_{duct}} \qquad ( 12 )$$

The velocity ratio, as defined by Equation (13) and adapted from Zhong, S. M. Jabbal, H. Tang, L. Garcillan, F. Guo, N. Wood, C. Warsop, “Towards the Design of Synthetic-jet Actuators for Full-scale Flight Conditions, Part 1: The Fluid Mechanics of Synthetic-jet Actuators,” Flow, Turbulence and Combustion, Vol. 78. No. 3-4, 2007, pp. 283-307, is also of interest in flow control applications. It is defined relative to the induced velocity through the duct, as this is the velocity representative of the flow on which the control is acting for this application. For the tests performed the synthetic jets operated in the range of VR=0.5 to 1.0, while the steady jets operated in the range of 1.5 to 5.

$${V}_{R} = \frac{{U}_{0}}{{V}_{induced}} \qquad ( 13 )$$

Static (hover) tests were performed for both the leading edge and trailing edge flow control configurations. While the concepts were designed to affect the vehicle horizontal flight at high angles of attack, the static capability of these flow control concepts was still of interest. The trailing edge Coanda flow control causes the duct flow to turn and thereby creates normal force. Because the steady blowing was powered by a separate supply of high-pressure air, higher blowing coefficient levels were explored to assess the full capability of the flow control concepts.

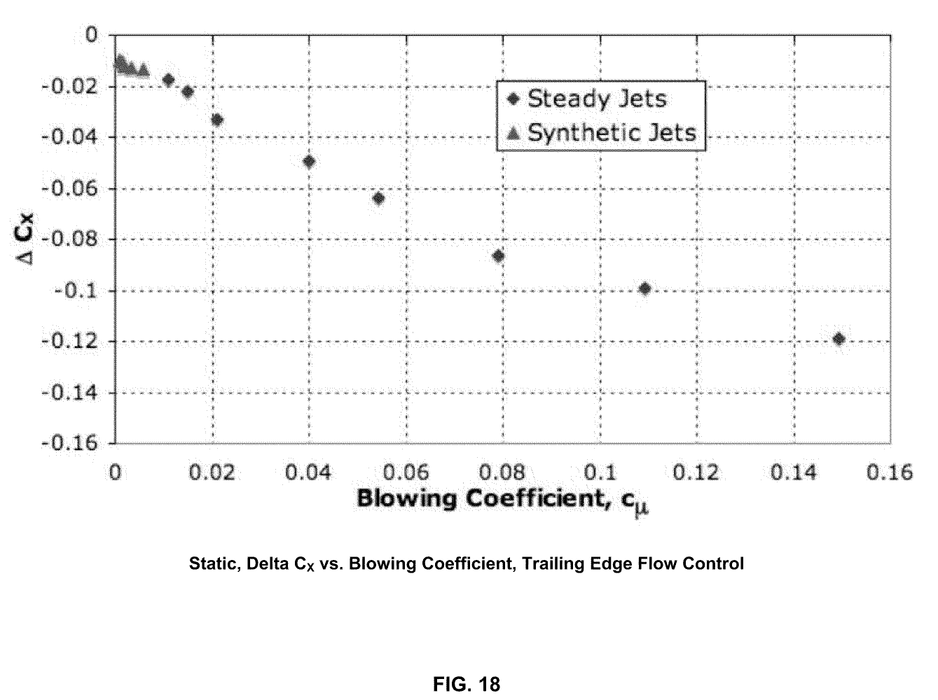

FIG. 18 is a graph of the normal force coefficient data versus jet momentum coefficient for static tests relating to trailing edge flow control. Data is presented in the form of deltas from the base vehicle aerodynamics since the jet blowing would be used as a control input to affect vehicle flight. FIG. 18 shows that the synthetic jets were not able to attain the same level of blowing coefficient, but do follow the same trend in force generation, or even exceed the magnitude of the trend for steady blowing.

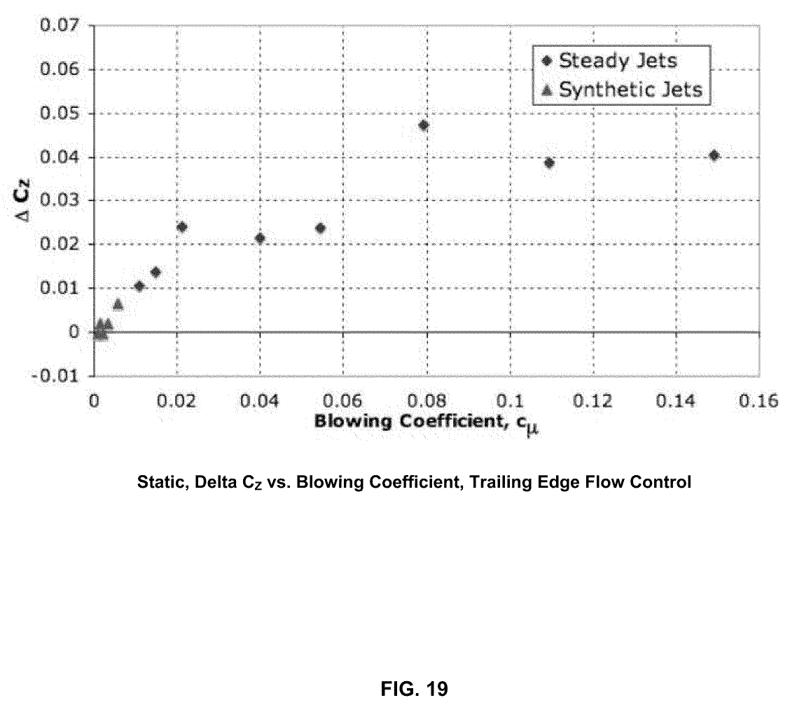

FIG. 19 is a graph of the effect on axial force of the trailing edge blowing. A positive delta to CZ corresponds to lower thrust. As the flow is expanded by the Coanda blowing, it effectively increases the exit area of the duct and decreases the exit velocity, thereby lowering the net thrust.

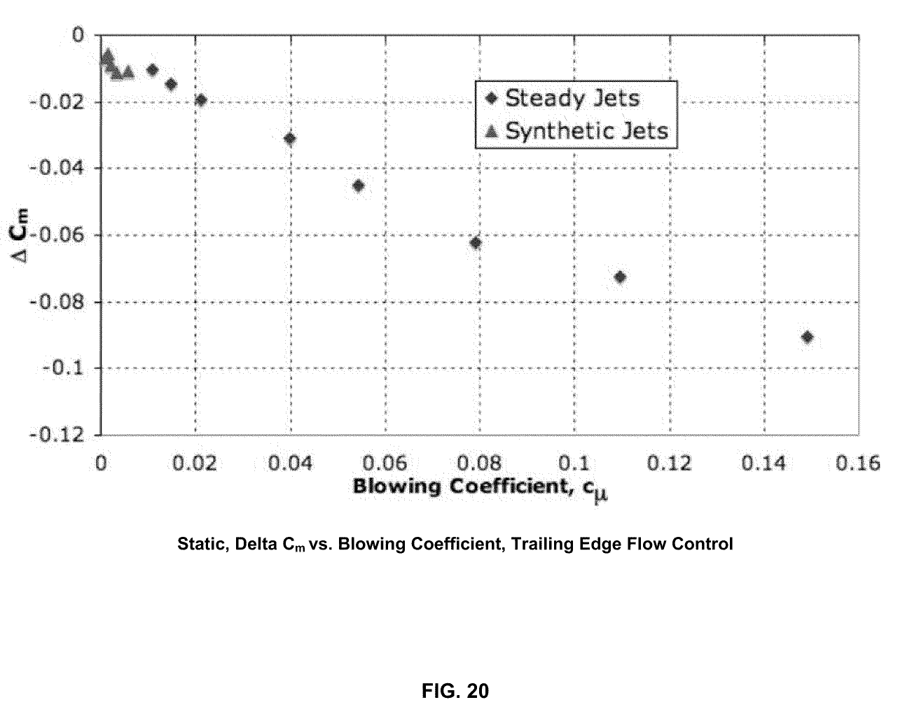

FIG. 20 is a graph showing the effect of trailing edge blowing on pitching moment coefficient, the primary objective of the concept. Both steady blowing and synthetic jet blowing produce the intended behavior, with the steady blowing reaching larger values than the synthetic jets due to higher blowing coefficient levels. Comparing the trends in the data, it would appear that the synthetic jets would affect pitching moment more for a given blowing coefficient.

The leading edge flow control produced very little effect in static conditions. This is attributed to the duct lip design for smooth and efficient flow in hover. Effectively, the flow is too stable in hover for the synthetic or steady blowing to cause significant separation on the duct lip. This however does not imply that it will not succeed for its target application of high angle of attack forward flight.

Before discussing the deltas to force and moment coefficients due to flow control for flight conditions, it is important to gain a reference point of the underlying vehicle aerodynamics.

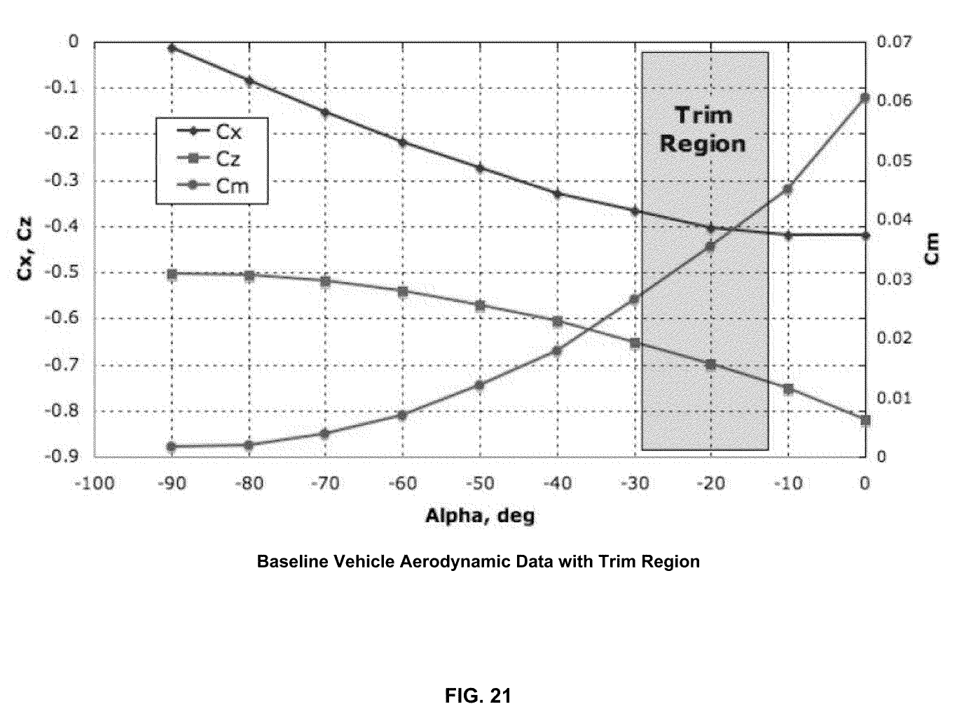

FIG. 21 provides a graph showing the baseline vehicle coefficient data for a pitch sweep at 35 ft/s. More specifically, FIG. 21 shows the range of CX, CZ, and Cm for the vehicle at a transition speed. The normal force and pitching moment are essentially zero at alpha of −90 degrees (nose directly into the wind), and increase in magnitude as alpha increases. The axial force (thrust) is at its lowest magnitude at alpha of −90 degrees (a pure axial climb orientation) and increases as well as the angle of attack increases. The ducted fan vehicle tilts into the wind to fly forward, and for this flight speed would pitch forward roughly −20 degrees. At this condition it is necessary to trim the pitching moment to zero for equilibrium flight, so a goal of −0.04 change in pitching moment coefficient would be sufficient to accomplish this.

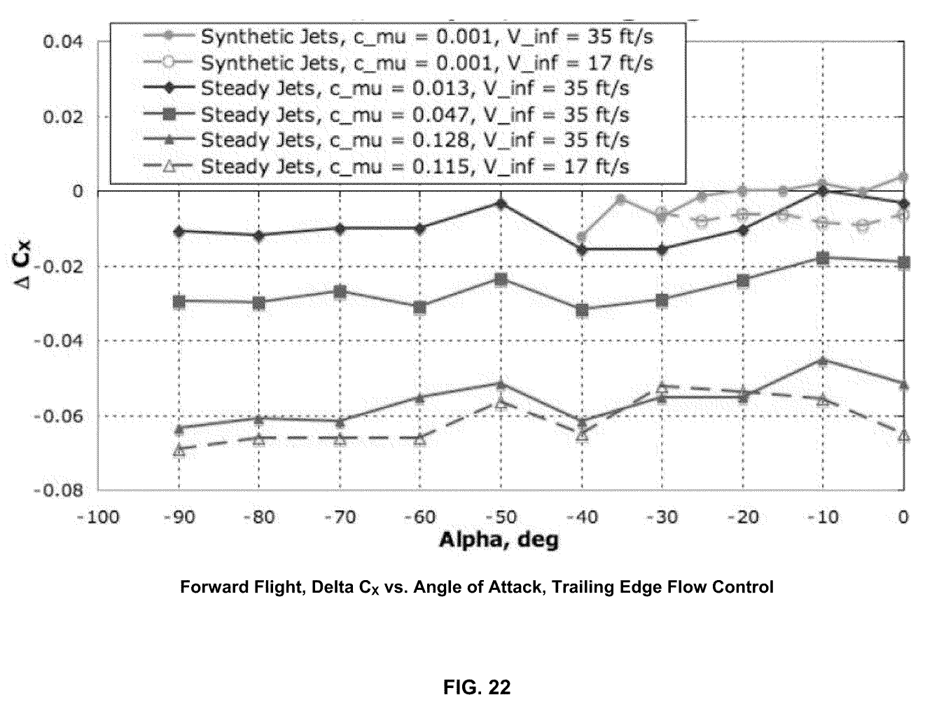

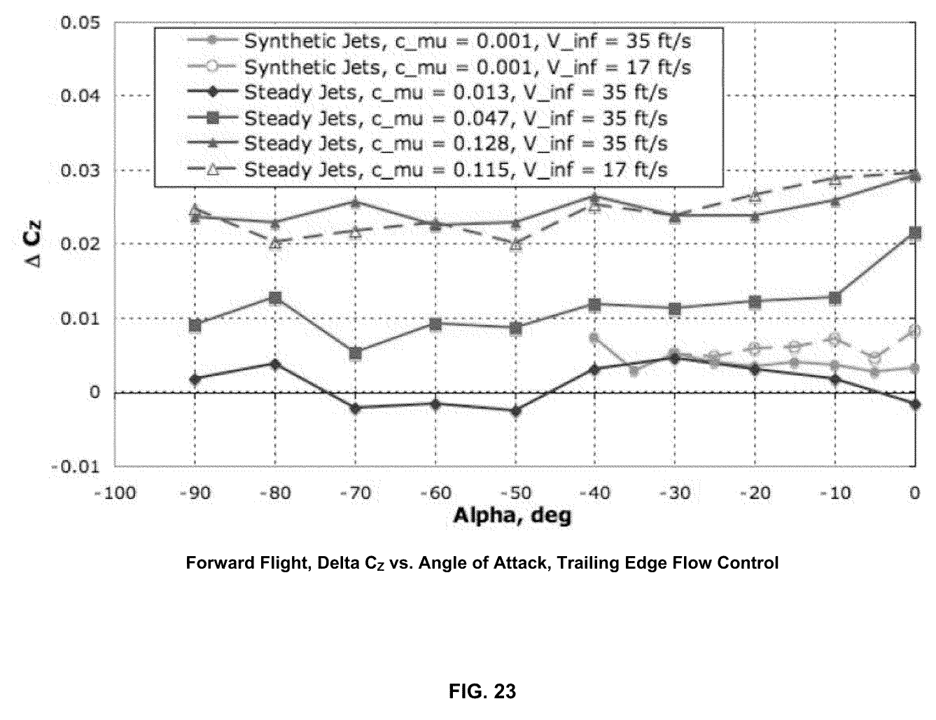

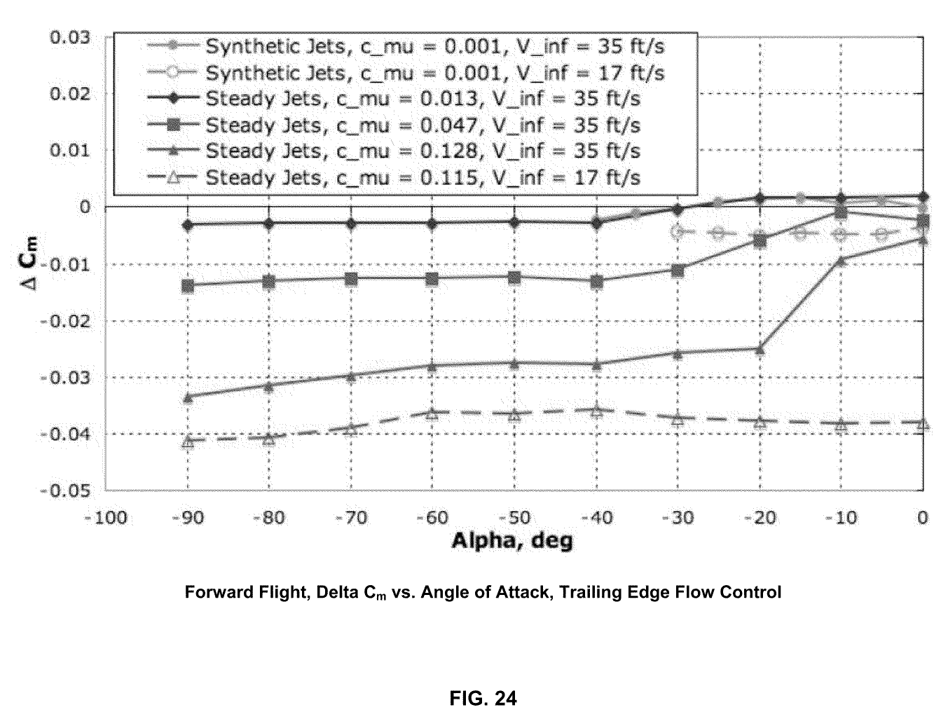

FIGS. 22-24 are graphs showing the wind tunnel test results for 17 ft/s and 35 ft/s (10 and 20 kt). The normal force results show the expected progression in magnitude of the steady blowing results as blowing coefficient increases. The flow control also seems to be slightly more effective at slower flight conditions (17 ft/s), and this would be supported by the fact that the static effects for comparable blowing coefficient were even larger magnitude (˜0.1). The same trend is observed in the synthetic jets, although the magnitude of the effects are much smaller due to the lower blowing coefficient.

The axial force coefficient results show that the flow expansion results in some thrust loss for forward flight as it did in hover. One aspect to note is that the normal force produced by the flow control is more than double the amount of thrust force lost.

The trailing edge flow control does have a significant effect on vehicle pitching moment. For reference, the value of Cm is on the order of 0.04 for the trim angle of attack of −20 degrees at 35 ft/s, and 0.035 for a trim angle of attack of −10 degrees at 17 ft/s. The highest level of trailing edge blowing can completely cancel that moment for 17 ft/s flight and comes very close for 35 ft/s. It should be noted that this is a very high level of blowing and the synthetic jets are much less effective because of the substantially lower blowing coefficient levels. Again, the steady and synthetic jet flow control is more effective at a lower speed of forward flight, and the steady blowing results show a sudden decrease in effectiveness at high angles of attack (still close to trim region). This is due to the fact that the Coanda flow control is trying to turn the ducted fan flow in the opposite direction to the free-stream. As the free-stream flow becomes faster, it is more difficult to keep the Coanda flow attached. The conclusion is that the Coanda flow control is more effective at lower angles of attack where the turned flow is not directly competing with the freestream.

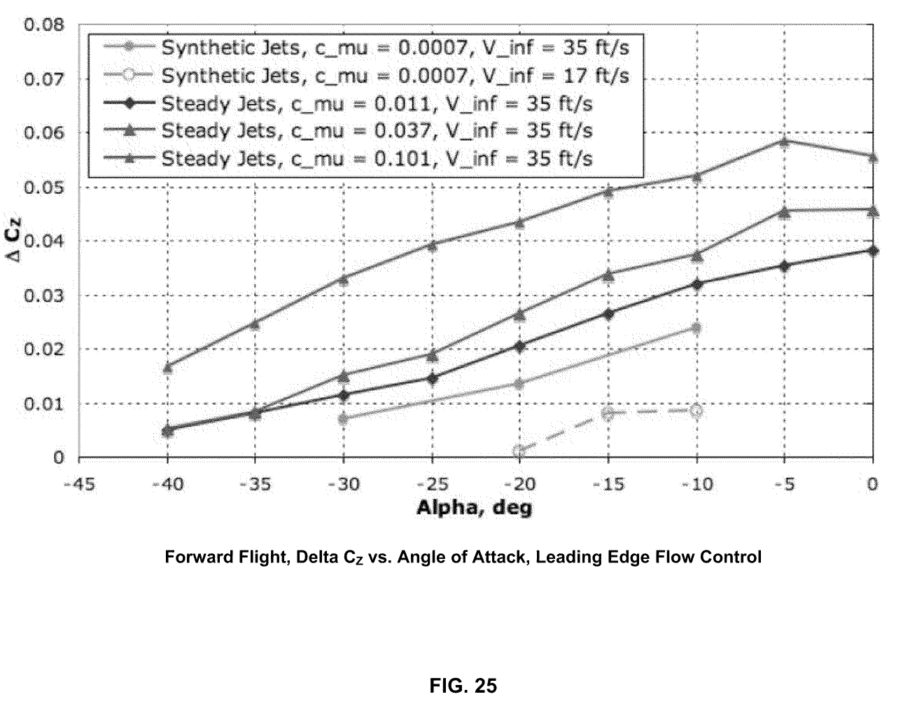

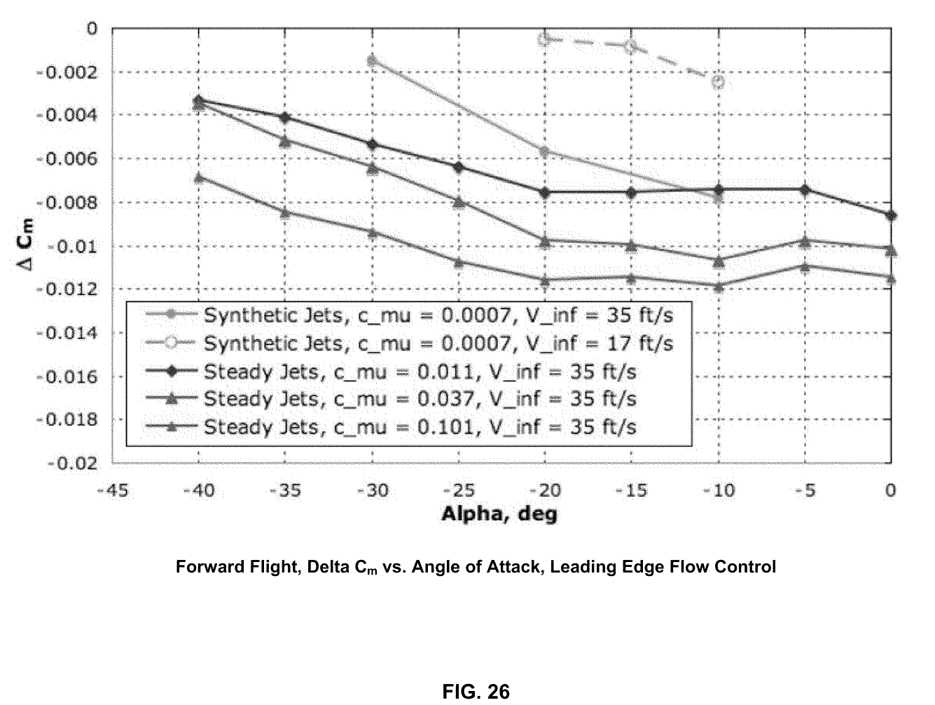

As shown in Example III, while the leading edge flow control showed little effect for the hover condition, it was effective at producing separation on the duct lip for high angle of attack forward flight, as seen in the flow visualization section. The leading edge concept does not affect normal force, but does produce results in axial force and pitching moment as seen in FIGS. 25 and 26.

While the trailing edge flow control concept corresponded to a control moment being created by generating a normal force, the leading edge concept shows the strong correlation between duct lip thrust and pitching moment. The separation caused on the lip results in thrust loss and decrease in pitching moment. The magnitudes of the deltas to pitching moment are roughly half of those seen in the steady trailing edge flow control, but the magnitudes increase with angle of attack whereas the trailing edge concept lost effectiveness at the conditions. These higher angles of attack are where the pitching moment is highest, and represent the area of greatest need for wind gust rejection. The deltas are smaller than the value needed for trim, so a solution based on this concept could only augment control and not be a complete solution for flight control actuation.

It should also be noted that the synthetic jets were much more effective in this configuration, but particularly at 35 ft/s instead of 17 ft/s. Even though the blowing coefficient for the synthetic jets is much lower than the steady blowing, the effects at 35 ft/s free-stream are comparable. What this suggests is that duct lip separation has more of a digital nature rather than a continuous behavior. In other words, there is a threshold that must be attained to cause separation through actuation, but further increases to actuation do not return as much benefit. This can be seen in the steady blowing as well, the greatest effect is seen going from no blowing to a blowing coefficient of 0.011. A blowing coefficient ten times greater only produces about 50% more effect on pitching moment. The lesson to be learned from this is that the nature of the flow one is trying to control is equally important or more important than the level of blowing being employed. In this particular application of causing separation in a flow that is somewhat unstable, synthetic jets were capable of creating a comparable effect but at a blowing coefficient that was a fraction of the steady blowing coefficient value.

These results show that the flow control concepts create an effect whether using steady blowing or synthetic jet blowing. Steady blow over the trailing edge Coanda surface in static conditions (no free stream airflow) resulted in significant control forces and moments. Synthetic jet blowing over the trailing edge Coanda surface produced smaller control forces and moments, but was a function of the overall output of the piezoelectric synthetic jets being lower than the high pressure air supply available during testing. It is believed that if greater velocity synthetic jet output is attained, the system performance will be as good or better than the steady blowing results. Smith, B. L., G. W. Swift, “A Comparison Between Synthetic Jets and Continuous Jets”, Experiments in Fluids, Vol. 34, 2003, pp 467-472.

The flow control concepts were proven to be successful in producing aerodynamic forces and moments on a ducted fan, although some required high values of steady blowing to create significant responses. The flow control techniques presented could be used as control inputs for ducted fan flight control or augmenting wind gust rejection performance. Attaining high blowing momentum coefficients from synthetic jets is challenging since the time-averaged velocity is only a function of the outstroke: from bench test experiments it was seen that the time-averaged velocity was roughly one fourth of the peak velocity observed during the outstroke. The synthetic jets operated at lower blowing momentum coefficients than the steady jets tested, and in general the ducted fan application required more flow control authority than the synthetic jets could impart. However, triggering leading edge separation was one application where synthetic jets showed comparable performance to steady jets of much higher blowing coefficients.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

1. An apparatus for causing separation between a surface of a ducted fan and a fluid flow comprising:
a ducted fan having a duct with a leading edge surface;
one or more slots in the leading edge surface disposed around a circumference of the leading edge surface, wherein each slot is an opening for an orifice;
an orifice associated with each slot and operably connected thereto;
a cavity associated with each orifice and operably connected thereto;
at least one steady or synthetic jet operably associated with each cavity and capable of being individually actuated to blow a flow out of the cavity, through the orifice, and through the slot;
such that during operation the flow from each slot is capable of causing a separation between the leading edge surface and a flow entering the duct;
and such that during operation the jets are capable of being actuated asymmetrically around the leading edge surface to produce control forces and moments.

2. The apparatus of claim 1, wherein the slots comprise about 75% of the circumference around which the slots are arranged.

3. The apparatus of claim 1, further comprising a synthetic jet geometry:
wherein the duct has an inside diameter and the slots are rectangular, have a width ranging from about 0.2% to about 0.5% of the duct inside diameter, and have a length ranging from about 5% to about 8% of the duct inside diameter;
wherein the cavities have a diameter ranging from about 8% to about 10% of the duct inside diameter, and a width ranging from about 5% to about 8% of the cavity diameter; and
wherein the orifices have a depth of about 10% of the cavity diameter, a width ranging from about 0.2% to about 0.5% of the duct inside diameter, and a length ranging from about 5% to about 8% of the duct inside diameter.

4. The apparatus of claim 1, wherein the orifices are oriented at about 45° relative to the leading edge surface, such that during operation the flow from the slots is capable of opposing, at about 45°, the flow entering the duct.

5. The apparatus of claim 1, wherein the ducted fan is capable of providing propulsion to a vehicle.

6. The apparatus of claim 1, wherein the jets are synthetic jets capable of providing unsteady blowing.

7. The apparatus of claim 6, wherein each synthetic jet comprises a piezoelectric diaphragm with an active surface forming a wall of the cavity.

8. The apparatus of claim 7, wherein the jets are capable of producing a lateral flow whereby the flow from each slot, while in the cavity, is parallel to the active surface of the piezoelectric diaphragm.

9. An apparatus for causing attachment between a surface of a ducted fan and a fluid flow comprising:
a ducted fan having a trailing edge region comprising an inner duct surface and a Coanda surface;
one or more slots in the trailing edge region disposed around a circumference of the Coanda surface, wherein each slot is an opening for an orifice;
an orifice associated with each slot and operably connected thereto;
a cavity associated with each orifice and operably connected thereto;
at least one steady or synthetic jet operably associated with each cavity and capable of being individually actuated to blow a flow out of the cavity, through the orifice, and through the slot;
such that during operation the flow from each slot is capable of causing a Coanda effect in a flow exiting the duct, whereby the flow exiting the duct has a tendency to attach to the Coanda surface;
and such that during operation the jets are capable of being actuated asymmetrically around the circumference to produce control forces and moments.

10. The apparatus of claim 9, wherein the slots comprise about 85% of the circumference around which the slots are arranged.

11. The apparatus of claim 9, further comprising a synthetic jet geometry:
wherein the duct has an inside diameter and the slots are rectangular or curved to follow the Coanda surface circumference, have a width ranging from about 0.2% to about 0.5% of the duct inside diameter, and have a length ranging from about 5% to about 8% of the duct inside diameter;
wherein the cavities have a diameter ranging from about 8% to about 10% of the duct inside diameter, and a width ranging from about 5% to about 8% of the cavity diameter; and
wherein the orifices have a depth of about 10% of the cavity diameter, a width ranging from about 0.2% to about 0.5% of the duct inside diameter, and a length ranging from about 5% to about 8% of the duct inside diameter.

12. The apparatus of claim 9, wherein the orifices are disposed under and parallel to the inner duct surface to deliver, during operation, the flow from each slot in a direction tangential to the Coanda surface and the flow exiting the duct.

13. The apparatus of claim 9, wherein the jets are synthetic jets capable of providing unsteady blowing.

14. The apparatus of claim 13, wherein each synthetic jet comprises a piezoelectric diaphragm with an active surface forming a wall of the cavity.

15. The apparatus of claim 14, wherein the synthetic jets produce lateral blowing whereby the flow from the slots, while in the cavity, is parallel to the active surface of the piezoelectric diaphragm.

16. A vertical take-off and landing (VTOL) ducted-fan vehicle comprising:
a ducted fan with a duct having a leading edge surface and a trailing edge region with an inner duct surface and a Coanda surface;
one or more slots in the leading edge surface, and optionally or alternatively in the trailing edge region, disposed around a circumference of the leading edge surface or Coanda surface, wherein each slot is an opening for an orifice;
an orifice associated with each slot and operably connected thereto;
a cavity associated with each orifice and operably connected thereto;
at least one steady or synthetic jet operably associated with each cavity and capable of being individually actuated to blow a flow out of the cavity, through the orifice, and through the slot;
such that during operation the flow from each slot in the leading edge surface is capable of causing a separation between the leading edge surface and a flow entering the duct, and the flow from each slot in the trailing edge region is capable of causing a Coanda effect in a flow exiting the duct, whereby the flow exiting the duct has a tendency to attach to the Coanda surface;
and such that during operation the jets are capable of being actuated asymmetrically around the leading edge surface or Coanda surface to produce control forces and moments for flight control.

17. The ducted-fan vehicle of claim 16, wherein the ducted fan is capable of providing propulsion.

18. The ducted-fan vehicle of claim 16, wherein the synthetic jets comprise piezo diaphragms.

19. A method of flight control of a ducted-fan vehicle comprising:
deterring a flow entering a duct of a ducted-fan vehicle from attaching to a leading edge surface of the duct; and
optionally or alternatively inducing a flow exiting the duct to attach to a Coanda surface of the duct;
by actuating synthetic jets incorporated into the leading edge surface or Coanda surface to produce unsteady blowing and cause control forces and moments for controlling flight of the ducted-fan vehicle.

20. The method of claim 19, wherein the jets are arranged to produce unsteady blowing at about a 45° angle relative to the leading edge surface.
